(19) United States
(12) Patent Application Publication
(10) Pub. No.: US 2020/0379367 A1
(43) Pub. Date: Dec. 3, 2020

(54) LIQUID DEVELOPER

(71) Applicant: Kao Corporation, Tokyo (JP)

(72) Inventors: Tatsuya YAMADA, Wakayama-shi (JP); Kunihiro KANO, Wakayama-shi (JP)

(73) Assignee: Kao Corporation, Tokyo (JP)

(21) Appl. No.: 16/971,102

(22) PCT Filed: May 20, 2019
(86) PCT No.: PCT/JP2019/019942

§ 371 Date: Aug. 19, 2020

(30) Foreign Application Priority Data
May 31, 2018 (JP) 2018-105015
May 31, 2018 (JP) 2018-105016

(51) Int. Cl. G03G 9/13; G03G 9/125; G03G 9/135

(52) U.S. Cl. CPC G03G 9/131; G03G 9/135; G03G 9/125

(57) ABSTRACT

A liquid developer containing toner particles containing a resin binder and a colorant, an amino group-containing copolymer, and an insulating liquid, wherein the resin binder contains a polyester-based resin, and wherein the amino group-containing copolymer is a polymerized product of a monomer A having an amino group and a monomer B represented by the formula (I):

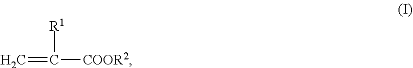

wherein R¹ is a hydrogen atom or a hydrocarbon group having 1 or more carbon atoms and 5 or less carbon atoms; and R² is a hydrocarbon group having 1 or more carbon atoms and 22 or less carbon atoms, which may have a substituent, wherein the liquid developer satisfies: Requirement 1: an amine value of the amino group-containing copolymer of 165 mgKOH/g or more, and a conductivity of the liquid developer being 5.0×10⁻⁹ S/m or less; or Requirement 2: the liquid developer further containing an acid compound. The liquid developer of the present invention is suitably used in development or the like of latent images formed in, for example, electrophotography, electrostatic recording method, electrostatic printing method or the like.

### FIELD OF THE INVENTION

The present invention relates to a liquid developer usable in development of latent images formed in, for example, electrophotography, electrostatic recording method, electrostatic printing method or the like.

### BACKGROUND OF THE INVENTION

Electrophotographic developers are a dry developer in which toner particles composed of materials containing a colorant and a resin binder are used in a dry state, and a liquid developer in which toner particles are dispersed in an insulating liquid.

In a liquid developer, toner particles are dispersed in oil in an insulating liquid, thereby making it possible to form smaller particle sizes as compared to a dry developer. Therefore, high-quality printouts can be obtained surpassing offset printing, so that the liquid developer is suitable for applications in commercial printings. In addition, in the recent years, since the demands for speeding up have been increasing and the toner particles are needed to be rapidly developed by electrophoresis, liquid developers with reduced viscosities and high chargeability have been desired. In addition, when toners insufficient in developing ability and cleaning ability are accumulated on a roller, filming is generated, thereby causing worsening of image quality or the like during a long-term printing. Therefore, toners having high chargeability are desired, also from the viewpoint of inhibiting filming and obtaining favorable durable printing ability.

Patent Publication 1 discloses a liquid developer containing toner particles containing a resin binder and a pigment and an insulating liquid, wherein the toner particles are dispersed in the insulating liquid in the presence of a dispersant, wherein the resin binder contains a polyester resin P having a glass transition temperature of 35° C. or higher, obtained by polycondensing raw material monomers containing an alcohol component containing 70% by mol or more and 100% by mol or less of an aliphatic diol having 2 or more carbon atoms and 6 or less carbon atoms, and a carboxylic acid component, and wherein the dispersant contains a copolymer obtained by copolymerization of a monomer A having an amino group and a monomer B having a particular structure, wherein a molar ratio of the monomer A to the monomer B, i.e., monomer A/monomer B, is 2/98 or more and 50/50 or less, and wherein in the monomer B, a molar ratio of a monomer B1 in which R² is an alkyl group having 1 or more carbon atoms and 9 or less carbon atoms or an alkenyl group having 2 or more carbon atoms and 9 or less carbon atoms to a monomer B2 in which R² is an alkyl group or alkenyl group having 10 or more carbon atoms and 22 or less carbon atoms, i.e., monomer B1/monomer B2, is 0 or more and 0.1 or less, and wherein an amine value is 150 mgKOH/g or less, for the purpose of providing a liquid developer having smaller particle sizes, a low viscosity, and excellent storage stability and low-temperature fusing ability, while inhibiting the elution of a resin binder to an insulating liquid.

Patent Publication 2 discloses a liquid developer containing toner particles, a polymer dispersant (C), and a carrier liquid (D), characterized in that the toner particles comprises a resin binder (A) and a colorant (B), and that the resin binder (A) comprises a crystalline resin (A-1) and an amorphous resin (A-2), and that the polymer dispersant (C) is obtained by copolymerizing ethylenically unsaturated monomers having an amino group and ethylenically unsaturated monomers containing an alkyl group having from 9 to 24 carbon atoms, and that an amine value is from 5 to 150 mgKOH/g, for the purpose of providing a liquid developer being capable of obtaining excellent optical density, having excellent fusing ability and anti-cold offset resistance, and having excellent storage stability over a long period of time.

Patent Publication 3 discloses a liquid developer comprising at least colored particles comprising a resin and a colored substance, and a liquid serving as a dispersion medium thereof, the colored particles being deposited on latent images on a latent image carrier to develop the latent images, characterized in that as a dispersion accelerating substance for accelerating the dispersion of the above colored particles in the above liquid, particles that are charged opposite to the colored particles are contained in the liquid in a proportion of from 0.05 to 20 parts by weight, based on 1 part by weight of the colored particles, for the purpose of providing a liquid developer capable of controlling all of unevenness in developing density caused by dispersion unevenness of colored particles, transfer failures caused by deficiency in the amount of liquids, and fusing failures caused by excess in the amount of liquids, without worsening the handling property due to the generation of a volatile gas.

Patent Publication 1: Japanese Patent Laid-Open No. 2017-010011

Patent Publication 2: Japanese Patent Laid-Open No. 2015-145985

Patent Publication 3: Japanese Patent Laid-Open No. 2004-302436

### SUMMARY OF THE INVENTION

The present invention relates to:

[1] a liquid developer containing toner particles containing a resin binder and a colorant, an amino group-containing copolymer, and an insulating liquid, wherein the resin binder contains a polyester-based resin, and wherein the amino group-containing copolymer is a polymerized product of a monomer A having an amino group and a monomer B represented by the formula (I):

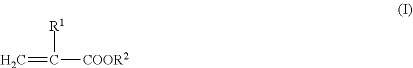

wherein R¹ is a hydrogen atom or a hydrocarbon group having 1 or more carbon atoms and 5 or less carbon atoms; and R² is a hydrocarbon group having 1 or more carbon atoms and 22 or less carbon atoms, which may have a substituent,

wherein the liquid developer satisfies:
Requirement 1: an amine value of the amino group-containing copolymer being 165 mgKOH/g or more, and a conductivity of the liquid developer being 5.0×10⁻⁹ S/m or less; or
Requirement 2: the liquid developer further containing an acid compound; and
[2] use of a composition containing toner particles containing a resin binder and a colorant, an amino group-containing copolymer, and an insulating liquid, wherein the resin binder contains a polyester-based resin, and wherein the amino group-containing copolymer is a polymerized product of a monomer A having an amino group and a monomer B represented by the formula (I), wherein the liquid developer satisfies:
Requirement 1: an amine value of the amino group-containing copolymer being 165 mgKOH/g or more, and a conductivity of the liquid developer being 5.0×10⁻⁹ S/m or less; or
Requirement 2: the liquid developer further containing an acid compound
as a liquid developer.

### DETAILED DESCRIPTION OF THE INVENTION

However, in the conventional techniques, the lowering in the viscosities and chargeability and storage stability of the liquid developers are insufficient, and it is difficult to perform high-speed printing while maintaining excellent durable printing. In particular, a polyester-based resin which is widely used as a resin binder is more likely to be negatively charged because the resin binder has an acid group, so that there are some disadvantages in chargeability when used in a positively chargeable liquid developer.

The present invention relates to a liquid developer containing a polyester-based resin, and having smaller particle sizes, a low viscosity and excellent storage stability and positive chargeability.

The liquid developer of the present invention exhibits some effects of having smaller particle sizes, a low viscosity and excellent storage stability and positive chargeability, even when a polyester-based resin is contained.

The liquid developer of the present invention contains toner particles containing a resin binder containing a polyester-based resin and a colorant, and an insulating liquid, the liquid developer further containing an amino group-containing copolymer having a high amine value as a dispersant, wherein the liquid developer satisfies:

Requirement 1: an amine value of the amino group-containing copolymer being 165 mgKOH/g or more, and a conductivity of the liquid developer being 5.0×10⁻⁹ S/m or less; or
Requirement 2: the liquid developer further containing an acid compound,
the liquid developer having small particle sizes, a low viscosity and excellent storage stability and positive chargeability.

Although the reasons why such effects are exhibited are not ascertained, they are considered to be as follows.

The amino group-containing copolymer is likely to adsorbed to the toner particles containing a polyester-based resin by acid-base interactions. Further, it is considered that particles bear positive chargeability by charging protons from an acid monomer or the like contained in the polyester-based resin to an amino group of the dispersant adsorbed to the toners.

In a case where Requirement 1 is satisfied, it is considered that the amino group-containing copolymer having a high amine value has many amino groups in the molecule which are likely to accept protons, so that the positive chargeability is improved. Further, the amino group-containing copolymer having a high amine value has a high adsorbability to the toner particles, the free dispersants are less found, and an increase in conductivity can be inhibited, so that the liquid developer has a low viscosity and excellent storage stability.

In addition, in a case where Requirement 2 is satisfied, in other words, a case where an acid compound is further present in the system, it is considered that the positive chargeability of the particles is improved by charging protons from an acid compound to an amino group of the amino group-containing copolymer adsorbed to the toner particles.

Further, since the amino group-containing copolymer in the present invention, as described later, has a carbon chain, when adsorbed to toners, the part of the carbon chain having a high affinity to the insulating liquid are spread, thereby exhibiting steric repulsions between the toner particles, whereby the aggregation of the toner particles and an increased viscosity of the liquid developer can be inhibited. Therefore, it is considered that the liquid developer of the present invention has excellent smaller particle sizes, lowered viscosity and storage stability.

A liquid developer that satisfies Requirement 1 is hereinafter referred as an embodiment A, and a liquid developer that satisfies Requirement 2 is hereinafter referred to as an embodiment B.

The resin binder contains a polyester-based resin.

The polyester-based resin includes, but not particularly limited to, for example, polyester resins, composite resins containing polyester resins and other resins, such as styrenic resins, and the like.

It is preferable that the polyester resin is a polycondensate of an alcohol component containing a dihydric or higher polyhydric alcohol, and a carboxylic acid component containing a dicarboxylic or higher polycarboxylic acid compound.

The dihydric alcohol includes, for example, aliphatic diols having 2 or more carbon atoms and 20 or less carbon atoms, and preferably having 2 or more carbon atoms and 15 or less carbon atoms; an alkylene oxide adduct of bisphenol A represented by the formula (II):

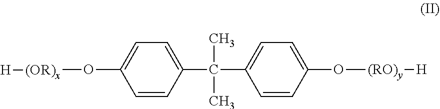

wherein OR and RO are an oxyalkylene group, wherein R is an ethylene group and/or a propylene group; and each of x and y is a positive number showing an average number of moles of alkylene oxide added, wherein a value of the sum of x and y is 1 or more, and preferably 1.5 or more, and 16 or less, preferably 8 or less, more preferably 6 or less, and even more preferably 4 or less,

bisphenol A, hydrogenated bisphenol A, and the like. The aliphatic diol includes ethylene glycol, 1,2-propanediol, 1,3-propanediol, 1,4-butanediol, 1,6-hexanediol, and the like. Among them, an aliphatic diol having a hydroxyl group bonded to a secondary carbon atom having 3 or more carbon atoms and 5 or less carbon atoms is preferred.

The alcohol component is preferably 1,2-propanediol or the alkylene oxide adduct of bisphenol A represented by the formula (II), from the viewpoint of improving pulverizability of the toner, thereby obtaining the toner particles having smaller particle sizes, from the viewpoint of improving low-temperature fusing ability of the toner, and from the viewpoint of improving dispersion stability of the toner particles, thereby improving storage stability. The content of 1,2-propanediol or the alkylene oxide adduct of bisphenol A represented by the formula (II) is preferably 50% by mol or more, more preferably 70% by mol or more, even more preferably 90% by mol or more, even more preferably 95% by mol or more, and even more preferably 100% by mol, of the alcohol component. When 1,2-propanediol and the alkylene oxide adduct of bisphenol A represented by the formula (II) are used together, it is preferable that a total content of the both is within the above range.

The trihydric or higher polyhydric alcohol includes trihydric or higher polyhydric alcohols having 3 or more carbon atoms and 20 or less carbon atoms, and preferably having 3 or more carbon atoms and 10 or less carbon atoms. Specific examples include sorbitol, 1,4-sorbitan, pentaerythritol, glycerol, trimethylolpropane, and the like.

The dicarboxylic acid compound includes, for example, dicarboxylic acids having 3 or more carbon atoms and 30 or less carbon atoms, preferably having 3 or more carbon atoms and 20 or less carbon atoms, and more preferably having 3 or more carbon atoms and 10 or less carbon atoms, or anhydrides thereof, derivatives thereof such as alkyl esters of which alkyl group has 1 or more carbon atoms and 3 or less carbon atoms, and the like. Specific examples of the dicarboxylic acid include aromatic dicarboxylic acids such as phthalic acid, isophthalic acid, and terephthalic acid; aliphatic dicarboxylic acids such as fumaric acid, maleic acid, succinic acid, glutaric acid, adipic acid, sebacic acid, and succinic acid substituted with an alkyl group having 1 or more carbon atoms and 20 or less carbon atoms or with an alkenyl group having 2 or more carbon atoms and 20 or less carbon atoms, and the like.

The carboxylic acid component is preferably terephthalic acid or/and fumaric acid, from the viewpoint of improving low-temperature fusing ability of the toner, and from the viewpoint of improving dispersion stability of the toner particles, thereby improving storage stability. The content of the terephthalic acid or fumaric acid in the carboxylic acid component is preferably 40% by mol or more, more preferably 50% by mol or more, and even more preferably 70% by mol or more, and preferably 95% by mol or less, more preferably 93% by mol or less, and even more preferably 90% by mol or less. When terephthalic acid and fumaric acid are used together, it is preferable that a total content of the both is within the above range.

The tricarboxylic or higher polycarboxylic acid compound includes, for example, tricarboxylic or higher polycarboxylic acids having 4 or more carbon atoms and 20 or less carbon atoms, preferably having 6 or more carbon atoms and 20 or less carbon atoms, more preferably having 7 or more carbon atoms and 15 or less carbon atoms, even more preferably having 8 or more carbon atoms and 12 or less carbon atoms, and even more preferably having 9 or more carbon atoms and 10 or less carbon atoms, or anhydrides thereof, derivatives thereof such as alkyl esters of which alkyl group has 1 or more carbon atoms and 3 or less carbon atoms and the like. Specific examples include 1,2,4-benzenetricarboxylic acid (trimellitic acid), 1,2,4,5-benzenetetracarboxylic acid (pyromellitic acid), or acid anhydrides thereof, and the like.

The content of the tricarboxylic or higher polycarboxylic acid compound in the carboxylic acid component is preferably 1% by mol or more, more preferably 2% by mol or more, and even more preferably 3% by mol or more, from the viewpoint of adsorbability of the amino group-containing copolymer to the toner particles, and the content is preferably 30% by mol or less, more preferably 25% by mol or less, and even more preferably 20% by mol or less, from the viewpoint of improving dispersion stability of the toner particles, thereby improving the storage stability.

In addition, the carboxylic acid component may contain an acid modified product of an α-olefin polymer.

Here, the alcohol component may contain a monohydric alcohol, and the carboxylic acid component may contain a monocarboxylic acid compound in proper amounts, from the viewpoint of adjusting a molecular weight and a softening point of the polyester resin.

The equivalent ratio of the carboxylic acid component to the alcohol component in the polyester resin, i.e. COOH group or groups/OH group or groups, is preferably 0.6 or more, more preferably 0.7 or more, and even more preferably 0.75 or more, and preferably 1.1 or less, more preferably 1.05 or less, and even more preferably 1 or less, from the viewpoint of adjusting a softening point of the polyester resin.

The polyester resin can be produced, for example, by polycondensing the alcohol component and the carboxylic acid component in an inert gas atmosphere at a temperature of preferably 130° C. or higher, and more preferably 170° C. or higher, and preferably 250° C. or lower, and more preferably 240° C. or lower, preferably in the presence of an esterification catalyst, further optionally in the presence of an esterification promoter, a polymerization inhibitor or the like.

The esterification catalyst includes tin compounds such as dibutyltin oxide and tin(II) 2-ethylhexanoate; titanium compounds such as titanium diisopropylate bistriethanolaminate; and the like, and the tin compounds are preferred. The amount of the esterification catalyst used is preferably 0.01 parts by mass or more, and more preferably 0.1 parts by mass or more, and preferably 1.5 parts by mass or less, and more preferably 1 part by mass or less, based on 100 parts by mass of a total amount of the alcohol component and the carboxylic acid component. The esterification promoter includes gallic acid, and the like. The amount of the esterification promoter used is preferably 0.001 parts by mass or more, and more preferably 0.01 parts by mass or more, and preferably 0.5 parts by mass or less, and more preferably 0.1 parts by mass or less, based on 100 parts by mass of a total amount of the alcohol component and the carboxylic acid component. The polymerization inhibitor includes t-butyl catechol, and the like. The amount of the polymerization inhibitor used is preferably 0.001 parts by mass or more, and more preferably 0.01 parts by mass or more, and preferably 0.5 parts by mass or less, and more preferably 0.1 parts by mass or less, based on 100 parts by mass of a total amount of the alcohol component and the carboxylic acid component.

Here, in the present invention, the polyester resin may be a modified polyester resin to an extent that the properties thereof are not substantially impaired. The modified polyester resin includes, for example, a polyester resin grafted or blocked with a phenol, a urethane, an epoxy or the like according to a method described in Japanese Patent Laid-Open No. Hei-11-133668, Hei-10-239903, Hei-8-20636, or the like. Among the modified polyester resins, urethane-modified polyester resins in which polyester resins are urethane-extended with a polyisocyanate compound are preferred.

As a composite resin, a composite resin containing the above polyester resin and a styrenic resin is preferred.

The styrenic resin is a product of addition polymerization of raw material monomers containing at least styrene or a styrene derivative such as α-methylstyrene or vinyltoluene (hereinafter, the styrene and styrene derivatives are collectively referred to as “styrenic compound”).

The content of the styrenic compound, preferably styrene, in the raw material monomers for the styrenic resin, is preferably 50% by mass or more, more preferably 70% by mass or more, and even more preferably 80% by mass or more, from the viewpoint of improving dispersion stability of the toner particles, thereby improving storage stability, and the content is preferably 95% by mass or less, more preferably 93% by mass or less, and even more preferably 90% by mass or less, from the viewpoint of improving low-temperature fusing ability of the toner and from the viewpoint of improving wet milling property.

In addition, the styrenic resin may contain an alkyl (meth)acrylate of which alkyl group has 7 or more carbon atoms as a raw material monomer. The alkyl (meth)acrylate includes 2-ethylhexyl (meth)acrylate, (iso)octyl (meth)acrylate, (iso)decyl (meth)acrylate, (iso)stearyl (meth)acrylate, and the like. These alkyl (meth)acrylates are preferably used alone or in two or more kinds. Here, the expression “(iso)” as used herein means to embrace both cases where these groups are present and cases where they are absent, and in the cases where these groups are absent, they are normal form. Also, the expression “(meth)acrylic acid” is acrylic acid, methacrylic acid, or the both.

The content of the alkyl (meth)acrylate of which alkyl group has 7 or more carbon atoms in the raw material monomers for the styrenic resin is preferably 5% by mass or more, more preferably 7% by mass or more, and even more preferably 10% by mass or more, from the viewpoint of improving low-temperature fusing ability of the toner and from the viewpoint of improving wet milling property, and the content is preferably 50% by mass or less, more preferably 30% by mass or less, and even more preferably 20% by mass or less, from the viewpoint of improving dispersion stability of the toner particles, thereby improving storage stability.

The number of carbon atoms of the alkyl group in the alkyl (meth)acrylate as the raw material monomers for the styrenic resin is preferably 7 or more, and more preferably 8 or more, from the viewpoint of improving low-temperature fusing ability of the toner, and the number of carbon atoms is preferably 12 or less, and more preferably 10 or less, from the viewpoint of storage stability. Here, the number of carbon atoms of the alkyl ester refers to the number of carbon atoms derived from the alcohol component constituting the ester.

The raw material monomers for styrene resins may contain raw material monomers other than the styrenic compound and the alkyl (meth)acrylate, including, for example, ethylenically unsaturated monoolefins such as ethylene and propylene; diolefins such as butadiene; halovinyls such as vinyl chloride; vinyl esters such as vinyl acetate and vinyl propionate; ethylenically monocarboxylic acid esters such as dimethylaminoethyl (meth)acrylate; vinyl ethers such as vinyl methyl ether; vinylidene halides such as vinylidene chloride; N-vinyl compounds such as N-vinylpyrrolidone; and the like.

The addition polymerization reaction of the raw material monomers for the styrenic resin can be carried out, for example, in the presence of a polymerization initiator such as dicumyl peroxide, a polymerization inhibitor, a crosslinking agent, or the like, and in the presence of an organic solvent or in the absence of a solvent, and the temperature conditions are preferably 110° C. or higher, and more preferably 140° C. or higher, and preferably 200° C. or lower, and more preferably 170° C. or lower.

When an organic solvent is used during the addition polymerization reaction, xylene, toluene, methyl ethyl ketone, acetone or the like can be used. The amount of the organic solvent used is preferably 10 parts by mass or more and 50 parts by mass or less, based on 100 parts by mass of the raw material monomers for the styrenic resin.

In the present invention, it is preferable that the composite resin is a resin in which a polyester resin and a styrenic resin are chemically bonded via a dually reactive monomer, which is capable of reacting with both the raw material monomers for the polyester resin and the raw material monomers for the styrenic resin, from the viewpoint of dispersion stability and pulverizability of the toner particles.

The dually reactive monomer is preferably a compound having within its molecule at least one functional group selected from the group consisting of a hydroxyl group, a carboxy group, an epoxy group, a primary amino group and a secondary amino group, preferably a hydroxyl group and/or a carboxy group, and more preferably a carboxy group, and an ethylenically unsaturated bond, and the dually reactive monomer is more preferably at least one member selected from the group consisting of acrylic acid, methacrylic acid, fumaric acid, maleic acid, and maleic anhydride, and, from the viewpoint of reactivities of the polycondensation reaction and addition polymerization reaction, even more preferably at least one member selected from the group consisting of acrylic acid, methacrylic acid, and fumaric acid. Here, in a case where the dually reactive monomer is used together with a polymerization inhibitor, a polycarboxylic acid compound having an ethylenically unsaturated bond such as fumaric acid functions as a raw material monomer for a polyester resin. In this case, fumaric acid or the like is not a dually reactive monomer, but a raw material monomer for a polyester resin.

In addition, the dually reactive monomer may be one or more (meth)acrylate esters selected from acrylate esters and methacrylate esters of which alkyl group has 6 or less carbon atoms.

The (meth)acrylate ester is preferably an alkyl (meth)acrylate, from the viewpoint of reactivity to transesterification, and the alkyl group has the number of carbon atoms of preferably 2 or more, and more preferably 3 or more, and preferably 6 or less, and more preferably 4 or less. The alkyl group may have a substituent such as a hydroxyl group.

Specific examples of the alkyl (meth)acrylate include methyl (meth)acrylate, ethyl (meth)acrylate, (iso)propyl (meth)acrylate, 2-hydroxyethyl (meth)acrylate, (iso or tertiary)butyl (meth)acrylate, hexyl (meth)acrylate, and the like. Here, the expression “(iso or tertiary)” means to embrace both cases where these groups are present and cases where they are absent, and in the cases where these groups are absent, they are normal form.

In the present invention, the acrylate ester is preferably an alkyl acrylate of which alkyl group has 2 or more carbon atoms and 6 or less carbon atoms, and more preferably butyl acrylate, and the methacrylate ester is preferably an alkyl methacrylate of which alkyl group has 2 or more carbon atoms and 6 or less carbon atoms, and more preferably butyl methacrylate.

The amount of the dually reactive monomer used, based on 100 mol of a total of the alcohol component of the polyester resin, is preferably 1 mol or more, and more preferably 2 mol or more, from the viewpoint of enhancing dispersibility of the styrenic resin and the polyester resin, thereby improving durability of the toner, and the amount of the dually reactive monomer used is preferably 30 mol or less, more preferably 20 mol or less, and even more preferably 10 mol or less, from the viewpoint of low-temperature fusing ability.

In addition, the amount of the dually reactive monomer used, based on 100 parts by mass of a total of the raw material monomers for the styrenic resin, is preferably 1 part by mass or more, and more preferably 2 parts by mass or more, from the viewpoint of enhancing dispersibility of the styrenic resin and polyester resin, thereby improving durability of the toner, and the amount of the dually reactive monomer used is preferably 30 parts by mass or less, more preferably 20 parts by mass or less, and even more preferably 10 parts by mass or less, from the viewpoint of low-temperature fusing ability. Here, a total of the raw material monomers for the styrenic resin includes a polymerization initiator.

It is preferable that the composite resin obtained by using a dually reactive monomer is specifically produced in accordance with the following method. It is preferable that the dually reactive monomer is used in the addition polymerization reaction together with the raw material monomers for the styrenic resin, from the viewpoint of improving durability of the toner, and from the viewpoint of improving low-temperature fusing ability and heat-resistant storage property of the toner.

(i) Method including carrying out the step (A) a polycondensation reaction of raw material monomers for a polyester resin; and thereafter the step (B) an addition polymerization reaction of raw materials monomers for a styrenic resin and a dually reactive monomer

In this method, the step (A) is carried out under reaction temperature conditions appropriate for a polycondensation reaction, a reaction temperature is then lowered, and the step (B) is carried out under temperature conditions appropriate for an addition polymerization reaction. It is preferable that the raw material monomers for the styrenic resin and the dually reactive monomer are added to a reaction system at a temperature appropriate for an addition polymerization reaction. The dually reactive monomer also reacts with the polyester resin as well as in the addition polymerization reaction.

After the step (B), a reaction temperature is raised again, a raw material monomer which is a trivalent or higher polyvalent monomer for a polyester resin serving as a crosslinking agent is optionally added to the reaction system, whereby the polycondensation reaction of the step (A) and the reaction with the dually reactive monomer can be further progressed.

(ii) Method including carrying out the step (B) an addition polymerization reaction of raw material monomers for a styrenic resin and a dually reactive monomer, and thereafter the step (A) a polycondensation reaction of raw material monomers for a polyester resin

In this method, the step (B) is carried out under reaction temperature conditions appropriate for an addition polymerization reaction, a reaction temperature is then raised, and the step (A) a polycondensation reaction is carried out under temperature conditions appropriate for the polycondensation reaction. The dually reactive monomer is also involved in a polycondensation reaction as well as the addition polymerization reaction.

The raw material monomers for the polyester resin may be present in a reaction system during the addition polymerization reaction, or the raw material monomers for the polyester resin may be added to a reaction system under temperatures conditions appropriate for the polycondensation reaction. In the former case, the progress of the polycondensation reaction can be adjusted by adding an esterification catalyst at a temperature appropriate for the polycondensation reaction.

(iii) Method including carrying out reactions under the conditions of concurrently progressing the step (A) a polycondensation reaction of raw material monomers for a polyester resin and the step (B) an addition polymerization reaction of raw materials monomers for a styrenic resin and a dually reactive monomer

In this method, it is preferable that the steps (A) and (B) are concurrently carried out under reaction temperature conditions appropriate for an addition polymerization reaction, a reaction temperature is raised, a raw material monomer which is a trivalent or higher polyvalent monomer for the polyester resin serving as a crosslinking agent is optionally added to a polymerization system under temperature conditions appropriate for a polycondensation reaction, and the step (A) polycondensation reaction is further carried out. During the process, the polycondensation reaction alone can also be progressed by adding a radical polymerization inhibitor under temperature conditions appropriate for the polycondensation reaction. The dually reactive monomer is also involved in a polycondensation reaction as well as the addition polymerization reaction.

In the above method (i), a polycondensation resin that is previously polymerized may be used in place of the step (A) carrying out a polycondensation reaction. In the above method (iii), when the steps (A) and (B) are concurrently progressed, a mixture containing raw material monomers for the styrenic resin can be added dropwise to a mixture containing raw material monomers for the polyester resin to react.

It is preferable that the above methods (i) to (iii) are carried out in a same vessel.

The mass ratio of the styrenic resin to the polyester resin in the composite resin, i.e. styrenic resin/polyester resin, is preferably 3/97 or more, more preferably 7/93 or more, and even more preferably 10/90 or more, from the viewpoint of pulverizability of the toner particles, and the mass ratio is preferably 45/55 or less, more preferably 40/60 or less, even more preferably 35/65 or less, even more preferably 30/70 or less, and even more preferably 25/75 or less, from the viewpoint of dispersion stability of the toner particles. Here, in the above calculation, the mass of the polyester resin is an amount in which the amount of reaction water (calculated value) dehydrated by the polycondensation reaction is subtracted from the mass of the raw material monomers for the usable polyester resin, and the amount of the dually reactive monomer is included in the amount of the raw material monomers for the polyester resin. Also, the amount of the styrenic resin is a total amount of the raw material monomers for the styrenic resin and the polymerization initiator.

The softening point of the polyester-based resin is preferably 70° C. or higher, and more preferably 75° C. or higher, from the viewpoint of improving dispersion stability of the toner particles, thereby improving storage stability, and the softening point is preferably 160° C. or lower, more preferably 130° C. or lower, even more preferably 120° C. or lower, and even more preferably 110° C. or lower, from the viewpoint of improving low-temperature fusing ability of the toner.

The glass transition temperature of the polyester-based resin is preferably 40° C. or higher, and more preferably 45° C. or higher, from the viewpoint of improving dispersion stability of the toner particles, thereby improving storage stability, and the glass transition temperature is preferably 80° C. or lower, more preferably 70° C. or lower, and even more preferably 60° C. or lower, from the viewpoint of improving low-temperature fusing ability.

The acid value of the polyester-based resin is preferably 5 mgKOH/g or more, more preferably 10 mgKOH/g or more, and even more preferably 15 mgKOH/g or more, from the viewpoint of improving chargeability of the toner, and the acid value is preferably 70 mgKOH/g or less, more preferably 50 mgKOH/g or less, even more preferably 40 mgKOH/g or less, and even more preferably 20 mgKOH/g or less, from the viewpoint of improving dispersion stability of the toner particles, thereby improving storage stability. The acid value of the polyester-based resin can be adjusted by a method such as varying an equivalent ratio of the carboxylic acid component to the alcohol component, varying a reaction time during the production of the resin, or varying the content of the tricarboxylic or higher polycarboxylic acid compound.

The content of the polyester-based resin in the resin binder is preferably 90% by mass or more, more preferably 95% by mass or more, and even more preferably 100% by mass, i.e. only the polyester-based resin is used. However, other resins besides the polyester-based resin may be contained within the range that would not impair the effects of the present invention. The resins besides the polyester-based resin include, for example, one or more members selected from resins such as styrenic resins which are homopolymers or copolymers containing styrene or styrene substitutes, such as polystyrenes, styrene-propylene copolymers, styrene-butadiene copolymers, styrene-vinyl chloride copolymers, styrene-vinyl acetate copolymers, styrene-maleic acid copolymers, styrene-acrylate ester copolymers, and styrene-methacrylate ester copolymers, epoxy-based resins, rosin-modified maleic acid resins, polyethylene-based resins, polypropylene-based resins, polyurethane-based resins, silicone-based resins, phenolic resins, and aliphatic or alicyclic hydrocarbon resins.

As the colorant, dyes, pigments and the like which are used as colorants for toners can be used. Examples include carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazo yellow, and the like. In the present invention, the toner particles may be any one of black toners and color toners.

The content of the colorant is preferably 5 parts by mass or more, more preferably 10 parts by mass or more, and even more preferably 15 parts by mass or more, based on 100 parts by mass of the resin binder, from the viewpoint of improving optical density, and the content is preferably 100 parts by mass or less, more preferably 70 parts by mass or less, even more preferably 50 parts by mass or less, and even more preferably 30 parts by mass or less, based on 100 parts by mass of the resin binder, from the viewpoint of improving pulverizability of the toner, thereby forming smaller particle sizes, from the viewpoint of improving low-temperature fusing ability, and from the viewpoint of improving dispersion stability of the toner particles, thereby improving storage stability.

The toner particles may properly contain, in addition to the resin binder and the colorant, an additive such as a releasing agent, a charge control agent, a charge control resin, a magnetic particulate, a fluidity improver, an electric conductivity modifier, a reinforcing filler such as a fibrous material, an antioxidant, or a cleanability improver.

The method for producing toner particles includes

a method including melt-kneading toner raw materials containing a resin binder and a colorant, and pulverizing, preferably wet-milling, a melt-kneaded product obtained;

a method including mixing an aqueous resin binder dispersion and an aqueous colorant dispersion to unify the resin binder particles and the colorant particles;

a method including stirring an aqueous resin binder dispersion and a colorant at a high speed, and the like.

The method including melt-kneading toner raw materials and pulverizing, preferably wet-milling a melt-kneaded product obtained is preferred, from the viewpoint of improving developing ability and fusing ability.

First, it is preferable that the toner raw materials containing a resin binder, a colorant, optionally used additives and the like are previously mixed with a mixer such as a Henschel mixer, a Super mixer or a ball-mill, and the mixture is then fed to a kneader, and the Henschel mixer is more preferred, from the viewpoint of improving colorant dispersibility in the resin binder.

Next, the melt-kneading of toner raw materials can be carried out with a known kneader, such as a tightly closed kneader, a single-screw or twin-screw kneader, or a continuous open-roller type kneader. In the method for production of the present invention, an open-roller type kneader is preferred, from the viewpoint of improving colorant dispersibility, and from the viewpoint of improving an yield of the toner particles after pulverization.

The open-roller type kneader refers to a kneader of which melt-kneading unit is an open type, not being tightly closed, which can easily dissipate the kneading heat generated during the melt-kneading. The open-roller type kneader used in the present invention is provided with a plurality of feeding ports for raw materials and a discharging port for a kneaded product along the shaft direction of the roller, and it is preferable that the open-roller type kneader is a continuous open-roller type kneader, from the viewpoint of production efficiency.

Next, the melt-kneaded product is cooled to an extent that is pulverizable, and the cooled product is subjected to a pulverizing step and optionally a classifying step, whereby the toner particles can be obtained.

The pulverizing step may be carried out in divided multi-stages. For example, the melt-kneaded product may be roughly pulverized to a size of from 1 to 5 mm or so, and the roughly pulverized product may then be further finely pulverized. In addition, in order to improve productivity during the pulverizing step, the melt-kneaded product may be mixed with fine inorganic particles made of hydrophobic silica or the like, and then pulverized.

The pulverizer suitably used in the rough pulverization includes, for example, an atomizer, Rotoplex, and the like, or a hammer-mill or the like may be used. In addition, the pulverizer suitably used in the fine pulverization includes a fluidised bed opposed jet mill, an air jet mill, a mechanical mill, and the like.

The classifier usable in the classifying step includes an air classifier, a rotor type classifier, a sieve classifier, and the like. Here, the pulverizing step and the classifying step may be repeated as occasion demands.

The toner particles obtained in this step have a volume-median particle size D₅₀ of preferably 3 μm or more, and more preferably 4 μm or more, and preferably 15 μm or less, and more preferably 12 μm or less, from the viewpoint of improving productivity of the wet-milling step described later. Here, the volume-median particle size D₅₀ means a particle size of which cumulative volume frequency calculated on a volume percentage is 50% counted from the smaller particle sizes. Here, it is preferable that the toner particles are mixed with an amino group-containing copolymer, an insulating liquid, and further an acid compound in the embodiment B, and then further finely pulverized by wet-milling or the like.

The amino group-containing copolymer in the present invention is a polymerized product of a monomer A having an amino group, and a monomer B represented by the formula (I):

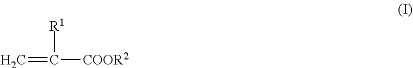

wherein R¹ is a hydrogen atom or a hydrocarbon group having 1 or more carbon atoms and 5 or less carbon atoms, and preferably a methyl group; and R² is a hydrocarbon group having 1 or more carbon atoms and 22 or less carbon atoms, and preferably an alkyl group having 1 or more carbon atoms and 22 or less carbon atoms or an alkenyl group having 2 or more carbon atoms and 22 or less carbon atoms, each of which may have a substituent, and the like.

It is preferable that the monomer A having an amino group is a monomer having an amino group represented by the formula (III):

CH₂═C(R⁵)COYR⁶NR³R⁴ (III)

wherein each of R³ and R⁴ is independently a hydrogen atom or a linear or branched alkyl group having 1 or more carbon atoms and 4 or less carbon atoms, which may be bonded to each other to form a ring structure; R⁵ is a hydrogen atom or an alkyl having 1 or more carbon atoms and 5 or less carbon atoms, and preferably a methyl group; R⁶ is a linear or branched alkylene group having 2 or more carbon atoms and 4 or less carbon atoms; and Y is —O— or —NH—, or
an acid neutralized product (tertiary amine salt) or a quaternary ammonium salt of this monomer. Preferred acids for obtaining the above acid neutralized product include hydrochloric acid, sulfuric acid, nitric acid, acetic acid, formic acid, maleic acid, fumaric acid, citric acid, tartaric acid, adipic acid, sulfamic acid, toluenesulfonic acid, lactic acid, pyrrolidone-2-carboxylic acid, succinic acid, and the like. The preferred quaternary forming agents for obtaining the above quaternary ammonium salt include alkyl halides such as methyl chloride, ethyl chloride, methyl bromide, and methyl iodide; and general alkylation agents such as dimethyl sulfate, diethyl sulfate, and di-n-propyl sulfate.

In the formula (III), each of R³ and R⁴ independently is preferably a linear or branched alkyl group having 1 or more carbon atoms and 4 or less carbon atoms, and NR³R⁴ is preferably a tertiary amino group. Specific examples of R³ and R⁴ include a methyl group, an ethyl group, a propyl group, an isopropyl group, and the like, and a methyl group is preferred.

R⁶ includes an ethylene group, a propylene group, a butylene group, and the like, and an ethylene group is preferred.

In the formula (III), specific examples of the monomer in which NR³R⁴ is a tertiary amino group (monomer having a tertiary amino group) include (meth)acrylic esters having a dialkylamino group, (meth)acrylamide having a dialkylamino group, and the like. Here, the term “(meth)acrylic ester” means to embrace both cases of acrylic ester and methacrylic ester, and the term “(meth)acrylamide” means to embrace both cases of acrylamide and methacrylamide.

The (meth)acrylic ester having a dialkylamino group includes one or more members selected from the group consisting of dimethylaminoethyl (meth)acrylate, diethylaminoethyl (meth)acrylate, dipropylaminoethyl (meth)acrylate, diisopropylaminoethyl (meth)acrylate, dibutylaminoethyl (meth)acrylate, diisobutylaminoethyl (meth)acrylate, and di-t-butylaminoethyl (meth)acrylate, and the like.

The (meth)acrylamide having a dialkylamino group includes one or more members selected from the group consisting of dimethylaminopropyl (meth)acrylamide, diethylaminopropyl (meth)acrylamide, dipropylaminopropyl (meth)acrylamide, diisopropylaminopropyl (meth)acrylamide, dibutylaminopropyl (meth)acrylamide, diisobutylaminopropyl (meth)acrylamide, and di-t-butylaminopropyl (meth)acrylamide, and the like.

Among them, the (meth)acrylic ester having a dialkylamino group is preferred, from the viewpoint of smaller particle sizes, lowered viscosity, storage stability, and low-temperature fusing ability, and dimethylaminoethyl (meth)acrylate or diethylaminoethyl (meth)acrylate is more preferred.

The monomer B is represented by the above formula (I), and in the above formula (I), the number of carbon atoms of the alkyl group and the alkenyl group represented by R² is preferably 10 or more, and more preferably 12 or more, from the viewpoint of lowered viscosity, storage stability, and low-temperature fusing ability, and the number of carbon atoms is 22 or less, and preferably 20 or less, from the viewpoint of adsorbability to the toner particles. The alkyl group or alkenyl group of R² may be linear or branched, which may have a substituent such as a hydroxyl group.

Therefore, it is preferable that the monomer B at least contains a monomer B2 in which R² is an alkyl group or alkenyl group having 10 or more carbon atoms and 22 or less carbon atoms.

In the monomer B, a molar ratio of a monomer B1 in which R² is an alkyl group having 1 or more carbon atoms and 9 or less carbon atoms or an alkenyl group having 2 or more carbon atoms and 9 or less carbon atoms to a monomer B2 in which R² is an alkyl group or alkenyl group having 10 or more carbon atoms and 22 or less carbon atoms, i.e. monomer B1/monomer B2, is preferably 0.1 or less, more preferably 0.07 or less, even more preferably 0.05 or less, even more preferably 0.03 or less, and even more preferably 0.01 or less, and 0 or more, and preferably 0, from the viewpoint of lowered viscosity, storage stability, and low-temperature fusing ability.

Specific examples of the monomer B include methyl (meth)acrylate, ethyl (meth)acrylate, (iso)propyl (meth)acrylate, 2-hydroxyethyl (meth)acrylate, (iso or tertiary)butyl (meth)acrylate, 2-ethylhexyl (meth)acrylate, (iso)octyl (meth)acrylate, (iso)nonyl (meth)acrylate, (iso)decyl (meth)acrylate, (iso)undecyl (meth)acrylate, (iso)dodecyl (meth)acrylate, (iso)tridecyl (meth)acrylate, (iso)tetradecyl (meth)acrylate, (iso)pentadecyl (meth)acrylate, (iso)hexadecyl (meth)acrylate, (iso)heptadecyl (meth)acrylate, (iso)octadecyl (meth)acrylate, (iso)nonadecyl (meth)acrylate, (iso)icosyl (meth)acrylate, (iso)eicosyl (meth)acrylate, (iso)henicosyl (meth)acrylate, (iso)docosyl (meth)acrylate, and the like. These monomers can be used alone or in two or more kinds. Here, the expression “(iso or tertiary)” or “(iso)” means to embrace both cases where these groups are present and cases where they are absent, and in the cases where these groups are absent, they are normal form. Also, the expression “(meth)acrylate” means to embrace both acrylate and methacrylate.

The mass ratio of the monomer A to the monomer B, i.e., monomer A/monomer B, in the embodiment A is preferably 50/50 or more, from the viewpoint of improving the chargeability of the toner, and the mass ratio is preferably 80/20 or less, more preferably 70/30 or less, and even more preferably 60/40 or less, from the viewpoint of improving dispersion stability of the toner particles, thereby improving storage stability, and from the viewpoint of increased resistance of the liquid developer.

The mass ratio of the monomer A to the monomer B, i.e., monomer A/monomer B, in the embodiment B is preferably 20/80 or more, more preferably 35/65 or more, and even preferably 45/55 or more, from the viewpoint of improving the chargeability of the toner, and the mass ratio is preferably 80/20 or less, more preferably 65/35 or less, and even more preferably 55/45 or less, from the viewpoint of improving dispersion stability of the toner particles, thereby improving storage stability, and from the viewpoint of increased resistance of the liquid developer.

A total content of the monomer A and the monomer B is preferably 80% by mass or more, more preferably 90% by mass or more, and even more preferably 95% by mass or more, and preferably 100% by mass or less, and more preferably 100% by mass, of the entire monomers usable in the amino-group containing copolymer.

The polymerization of a monomer A and a monomer B can be carried out, for example, by heating the monomers in a solvent to a temperature of 40° to 140° C. or so in the presence of a polymerization initiator such as 2,2′-azobis(2,4-dimethylvaleronitrile) to react.

The amine value of the amino group-containing copolymer in the embodiment A is 165 mgKOH/g or more, and preferably 170 mgKOH/g or more, from the viewpoint of improving the chargeability of the toner, and the amine value is preferably 300 mgKOH/g or less, more preferably 250 mgKOH/g or less, and even more preferably 200 mgKOH/g or less, from the viewpoint of improving dispersion stability of the toner particles, thereby improving storage stability, and from the viewpoint of increased resistance of the liquid developer.

The amine value of the amino group-containing copolymer in the embodiment B is preferably 80 mgKOH/g or more, more preferably 130 mgKOH/g or more, and even more preferably 150 mgKOH/g or more, from the viewpoint of improving the chargeability of the toner, and the amine value is preferably 300 mgKOH/g or less, more preferably 250 mgKOH/g or less, and even more preferably 200 mgKOH/g or less, from the viewpoint of improving dispersion stability of the toner particles, thereby improving storage stability, and from the viewpoint of increased resistance of the liquid developer.

In addition, the number-average molecular weight of the amino-group containing copolymer in both the embodiments is preferably 2,000 or more, more preferably 2,500 or more, even more preferably 3,000 or more, and even more preferably 3,500 or more, from the viewpoint of lowered viscosity and low-temperature fusing ability, and the number-average molecular weight is preferably 10,000 or less, more preferably 9,000 or less, and even more preferably 8,000 or less, from the same viewpoint.

The weight-average molecular weight of the amino-group containing copolymer in both the embodiments is preferably 5,000 or more, more preferably 10,000 or more, and even more preferably 12,000 or more, from the viewpoint of lowered viscosity and low-temperature fusing ability, and the weight-average molecular weight is preferably 100,000 or less, more preferably 50,000 or less, and even more preferably 20,000 or less, from the same viewpoint.

The content of the amino-group containing copolymer in the embodiment A, based on 100 parts by mass of the toner particles, is preferably 1 part by mass or more, more preferably 3 parts by mass or more, and even more preferably 4 parts by mass or more, from the viewpoint of improving dispersion stability of the toner particles, thereby improving storage stability, and the content is preferably 10 parts by mass or less, more preferably 8 parts by mass or less, and even more preferably 7 parts by mass or less, from the viewpoint of improving chargeability of the toner, and from the viewpoint of increased resistance of the liquid developer.

The content of the amino-group containing copolymer in the embodiment B, based on 100 parts by mass of the toner particles, is preferably 1 part by mass or more, more preferably 2 parts by mass or more, and even more preferably 3 parts by mass or more, from the viewpoint of improving dispersion stability of the toner particles, thereby improving storage stability, and the content is preferably 10 parts by mass or less, more preferably 8.5 parts by mass or less, more preferably 7 parts by mass or less, and even more preferably 5 parts by mass or less, from the viewpoint of improving chargeability of the toner, and from the viewpoint of increased resistance of the liquid developer.

The liquid developer of the present invention contains an amino group-containing copolymer mentioned above as a dispersant, and the liquid developer may contain a dispersant other than the amino group-containing copolymer mentioned above within the range that would not impair the effects of the present invention. The content of the amino group-containing copolymer in the dispersant is preferably 25% by mass or more, more preferably 40% by mass or more, more preferably 55% by mass or more, more preferably 70% by mass or more, more preferably 80% by mass or more, even more preferably 90% by mass or more, even more preferably 95% by mass or more, even more preferably 97% by mass or more, and even more preferably 100% by mass.

Other dispersants include, for example, polyallylamines, olefin/vinyl pyrrolidone copolymers, aliphatic amines and salts thereof, and the like.

The content of the dispersant usable in the present invention, based on 100 parts by mass of the toner particles, is preferably 1 part by mass or more, more preferably 2 parts by mass or more, more preferably 3 parts by mass or more, and even more preferably 4 parts by mass or more, from the viewpoint of improving dispersion stability of the toner particles, thereby improving storage stability, and the content is preferably 10 parts by mass or less, more preferably 8.5 parts by mass or less, and even more preferably 7 parts by mass or less, from the viewpoint of improving chargeability of the toner, and from the viewpoint of increased resistance of the liquid developer.

The liquid developer of the embodiment B further contains an acid compound.

The acid compound in the embodiment B is not particularly limited, and the acid compound is preferably an organic compound having an acid group, and more preferably an organic compound having a carboxy group. The organic compound having a carboxy group includes, for example, aliphatic acids, aliphatic dicarboxylic acids and anhydrides thereof, aromatic monocarboxylic acids, aromatic dicarboxylic acids and acid anhydrides thereof, polymer compounds having a carboxy group and acid anhydrides thereof, reaction products of the above polymer compounds having a carboxy group and anhydrides thereof and polymer compounds having a basic nitrogen-containing group, and the like. Among them, aliphatic acids, aliphatic dicarboxylic acids and anhydrides thereof, or polymer compounds having a carboxy group and anhydrides thereof are preferred, and the polymer compounds having a carboxy group and anhydrides thereof are more preferred.

Among aliphatic acids, aliphatic dicarboxylic acids and anhydrides thereof, aromatic monocarboxylic acids, aromatic dicarboxylic acids and anhydrides thereof, the aliphatic acids are preferred, from the viewpoint of improving chargeability of the toner, and from the viewpoint of increased resistance of the liquid developer. The number of carbon atoms of the aliphatic acid is preferably 8 or more, more preferably 12 or more, and even more preferably 16 or more, from the viewpoint of dissolubility in the insulating liquid and increased resistance of the liquid developer, and the number of carbon atoms is preferably 24 or less, more preferably 22 or less, and even more preferably 20 or less, from the viewpoint of dissolubility in the insulating liquid and lowered viscosities of the liquid developer.

The aliphatic acid may be a saturated aliphatic acid or an unsaturated aliphatic acid. In the present invention, the unsaturated aliphatic acid is preferred, from the viewpoint of improving dissolubility in the insulating liquid, and chargeability of the toner. The unsaturated aliphatic acid includes oleic acid, linoleic acid, erucic acid, myristoleic acid, palmitoleic acid, linolenic acid, and the like.

The polymer compound having a carboxy group includes polymers of a hydroxycarboxylic acid having 12 or more carbon atoms, polymers of a dibasic acid having 2 or more carbon atoms and 22 or less carbon atoms and a diol having 2 or more carbon atoms and 22 or less carbon atoms, polymers of an alkyl (meth)acrylate having a carboxy group, of which alkyl moiety has 16 or more carbon atoms, polyolefins having a carboxy group obtained by reacting a polyolefin and a carboxylic acid-based compound, and the like.

The polymers of a hydroxycarboxylic acid having 12 or more carbon atoms are preferably polymers of a hydroxycarboxylic acid having 12 or more carbon atoms and 24 or less carbon atoms, and preferably a hydroxycarboxylic acid having 16 or more carbon atoms and 24 or less carbon atoms, which includes, for example, polymers of 12-hydroxystearic acid, and the like.

The polymers of a dibasic acid having 2 or more carbon atoms and 22 or less carbon atoms and a diol having 2 or more carbon atoms and 22 or less carbon atoms include, for example, polymers of ethylene glycol and sebacic acid, polymers of 1,4-butanediol and fumaric acid, polymers of 1,6-hexanediol and fumaric acid, polymers of 1,10-decanediol and sebacic acid, polymers of 1,12-dodecanediol and 1,12-dodecanedionic acid, and the like.

The polymers of an alkyl (meth)acrylate having 16 or more carbon atoms are preferably polymers of an alkyl (meth)acrylate having 16 or more carbon atoms and 24 or less carbon atoms, which include, for example, polymers of hexadecyl methacrylate, polymers of octadecyl methacrylate, polymers of docosyl methacrylate, and the like.

The polyolefins include, for example, polyethylene, polypropylene, polybutylene, polyisobutene, polymethylpentene, polytetradecene, polyhexadecene, polyoctadecene, polyeicosene, polydocosene, and the like. The carboxylic acid-based compounds include fumaric acid, maleic acid, ethanoic acid, propanoic acid, butanoic acid, succinic acid, oxalic acid, malonic acid, tartaric acid, anhydrides thereof, alkyl esters thereof, the alkyl of which has 1 or more carbon atoms and 3 or less carbon atoms, and the like.

The number-average molecular weight of the polymer compound having a carboxy group is preferably 500 or more, more preferably 700 or more, and even more preferably 900 or more, from the viewpoint of dispersibility of the toner particles, and the number-average molecular weight is preferably 5,000 or less, more preferably 4,000 or less, and even more preferably 3,000 or less, from the viewpoint of adsorbability of the dispersant to the toner particles. The polyolefin having a carboxy group obtained by reacting a polyolefin and a carboxylic acid-based compound is preferably polyisobutene succinic anhydride having a number-average molecular weight of from 500 to 5,000.

It is preferable that the basic nitrogen-containing group is at least one member selected from the group consisting of amino groups (—NH₂, —NHR, —NHRR′), an amide group (—C(═O)—NRR′), an imide group (—N(COR)₂), a nitro group (—NO₂), an imino group (═NH), a cyano group (—CN), an azo group (—N═N—), a diazo group (═N₂), and an azide group (—N₃). Here, R or R′ is a hydrocarbon group having from 1 to 5 carbon atoms. The amino groups and/or the imino group is preferred, from the viewpoint of adsorbability of the dispersant to the toner particles, and the imino group is more preferred, from the viewpoint of chargeability of the toner particles.

Specific examples of the polymer compound having a basic nitrogen-containing group include polyalkyleneimines such as polyethyleneimines, polyallylamines, polyaminoalkyl methacrylates such as polydimethylaminoethyl methacrylates, and the like.

The number-average molecular weight of the polymer compound having a basic nitrogen-containing group is preferably 500 or more, more preferably 700 or more, and even more preferably 900 or more, from the viewpoint of dispersibility of the toner particles, and the number-average molecular weight is preferably 6,000 or less, more preferably 5,000 or less, and even more preferably 4,000 or less, from the viewpoint of adsorbability of the dispersant to the toner particles.

The mass ratio of the polymer compound having a basic nitrogen-containing group to the polymer compound having a carboxy group and anhydride thereof (polymer compound having a basic nitrogen-containing group/polymer compound having a carboxy group and anhydride thereof) in the reaction product is preferably 3/97 or more, and more preferably 5/95 or more, from the viewpoint of adsorbability to the toner particles, and the mass ratio is preferably 20/80 or less, and more preferably 15/85 or less, from the viewpoint of dispersion stability of the toner particles.

The content of the acid compound, based on 100 parts by mass of the toner particles, is preferably 0.5 parts by mass or more, more preferably 1 part by mass or more, and even more preferably 1.5 parts by mass or more, from the viewpoint of improving chargeability of the toner, and from the viewpoint of improving dispersion stability of the toner particles, thereby improving storage stability, and the content is preferably 8 parts by mass or less, more preferably 6 parts by mass or less, and even more preferably 5 parts by mass or less, from the viewpoint of improving chargeability of the toner, and from the viewpoint of increased resistance of the liquid developer.

In addition, the mass ratio of the amino group-containing copolymer to the acid compound (amino group-containing copolymer/acid compound) is preferably 20/80 or more, more preferably 30/70 or more, and even more preferably 40/60 or more, from the viewpoint of improving chargeability of the toner, and from the viewpoint of increased resistance of the liquid developer, and the mass ratio is preferably 95/5 or less, more preferably 90/10 or less, even more preferably 70/30 or less, and even more preferably 60/40 or less, from the viewpoint of improving chargeability of the toner, and from the viewpoint of improving dispersion stability of the toner particles, thereby improving storage stability.

The liquid developer of the embodiment B contains an amino group-containing copolymer mentioned above as a dispersant. Therefore, the liquid developer may contain other dispersants for liquid developers within the range that would not impair the effects of the present invention. However, the content of the amino group-containing copolymer is preferably 80% by mass or more, more preferably 90% by mass or more, even more preferably 95% by mass or more, even more preferably 97% by mass or more, and even more preferably 100% by mass, of the dispersant.

The insulating liquid in the present invention means a liquid through which electricity is less likely to flow, and in the present invention, the conductivity of the insulating liquid is preferably 1.0×10⁻¹⁰ S/m or less, more preferably 7.0×10⁻¹¹ S/m or less, and even more preferably 5.0×10⁻¹¹ S/m or less, and preferably 1.0×10⁻¹³ S/m or more.

The insulating liquid includes hydrocarbon-based insulating liquids such as aliphatic hydrocarbons, alicyclic hydrocarbons, and aromatic hydrocarbons, halogenated hydrocarbons, polysiloxanes, vegetable oils, and the like. In addition, since the above amino group-containing copolymer having a high amine value is more likely to be adsorbed to the toner particles in particularly a nonpolar insulating liquid, a free dispersant not being adsorbed to the toner is reduced, whereby an increase in conductivity can be controlled, so that it is preferable that the insulating liquid is nonpolar. In addition to these viewpoints, it is preferable that the insulating liquid in the present invention contains a hydrocarbon-based insulating liquid, from the viewpoint of improving dispersion stability of the toner particles, thereby improving storage stability. The hydrocarbon-based insulating liquid is preferably an acyclic hydrocarbon-based insulating liquid, from the viewpoint of reducing conductivity of the liquid developer, and from the viewpoint of improving dispersion stability of the toner particles, thereby improving storage stability. The content of the acyclic hydrocarbon-based insulating liquid is preferably 50% by mass or more, more preferably 70% by mass or more, more preferably 80% by mass or more, even more preferably 90% by mass or more, and even more preferably 100% by mass, of the insulating liquid. The acyclic hydrocarbon-based insulating liquid is preferably an aliphatic hydrocarbon-based solvent, and the insulting liquid is more preferably polyisobutene, from the viewpoint of dispersion stability and chargeability.

The polyisobutene in the present invention refers to a product obtained by polymerizing isobutene in accordance with a known method, for example, a cationic polymerization method using a catalyst, and thereafter hydrogenating the polymer at a terminal double bond.

The degree of polymerization of the polyisobutene is preferably 8 or less, more preferably 6 or less, even more preferably 5 or less, and even more preferably 4 or less, from the viewpoint of improving low-temperature fusing ability of the toner. In addition, the degree of polymerization is preferably 2 or more, and more preferably 3 or more, from the viewpoint of inhibiting corona charger contamination.

Commercially available products of the insulating liquid containing a polyisobutene include “NAS-3,” “NAS-4,” “NAS-5H,” hereinabove manufactured by NOF Corporation, and the like. These commercially available products can be used alone or in a combination of two or more kinds.

The content of the hydrocarbon-based insulating liquid is preferably 5% by mass or more, more preferably 20% by mass or more, even more preferably 40% by mass or more, even more preferably 60% by mass or more, even more preferably 80% by mass or more, and even more preferably 90% by mass or more, of the insulating liquid.

The boiling point of the insulating liquid, preferably the hydrocarbon-based insulating liquid, is preferably 120° C. or higher, more preferably 140° C. or higher, even more preferably 160° C. or higher, even more preferably 180° C. or higher, even more preferably 200° C. or higher, and even more preferably 220° C. or higher, from the viewpoint of inhibiting the increased viscosity of the liquid developer on a roller, thereby improving film-forming property, and the boiling point is preferably 300° C. or lower, more preferably 280° C. or lower, and even more preferably 260° C. or lower, from the viewpoint of even more improving low-temperature fusing ability of the toner, and from the viewpoint of even more improving pulverizability of the toner during wet-milling, thereby providing the toner particles having a smaller particle size. When two or more kinds of the insulating liquids are combined, it is preferable that the boiling point of the combined insulating liquid mixture is within the range defined above.

The viscosity at 25° C. of the liquid developer is preferably 1 mPa·s or more, and more preferably 1.5 mPa·s or more, and preferably 100 mPa·s or less, more preferably 50 mPa·s or less, even more preferably 20 mPa·s or less, even more preferably 10 mPa·s or less, and even more preferably 5 mPa·s or less, from the viewpoint of improving developing ability, and from the viewpoint of inhibiting the increased viscosity of the liquid developer on a roller, thereby improving film-forming property.

The liquid developer is obtained by mixing toner particles with a dispersant and an insulating liquid, and dispersing the mixture in an insulating liquid. It is preferable that toner particles are dispersed in an insulating liquid, and the dispersion is then subjected to wet-milling to provide a liquid developer, from the viewpoint of making particle sizes of the toner particles smaller. Here, in the production of a liquid developer of the embodiment B, toner particles, an amino group-containing copolymer, an acid compound and an insulating liquid may be mixed, and the mixture may be subjected to wet-milling It is preferable that a liquid developer is obtained by a method including mixing toner particles, an amino group-containing copolymer and an insulating liquid to provide a dispersion of toner particles, subjecting the dispersion of toner particles obtained to wet-milling, and mixing an acid compound therewith, from the viewpoint of improving chargeability of the toner.

It is preferable that a method for mixing toner particles, a dispersant, and an insulating liquid is a method including stirring the components with an agitation mixer, or the like.

The agitation mixer is, but not particularly limited to, preferably high-speed agitation mixers, from the viewpoint of improving productivity and storage stability of the dispersion of toner particles. Specific examples are preferably DESPA manufactured by ASADA IRON WORKS CO., LTD.; T.K. HOMOGENIZING MIXER, T.K. HOMOGENIZING DISPER, T.K. ROBOMIX, hereinabove manufactured by PRIMIX Corporation; CLEARMIX manufactured by M Technique Co., Ltd.; KADY Mill manufactured by KADY International, and the like.

The toner particles are previously dispersed by mixing components with a high-speed agitation mixer, whereby a dispersion of toner particles can be obtained, which in turn improves productivity of a liquid developer by the subsequent wet-milling

The solid content concentration of the dispersion of toner particles is preferably 20% by mass or more, more preferably 30% by mass or more, and even more preferably 33% by mass or more, from the viewpoint of improving optical density, and the solid content concentration is preferably 50% by mass or less, more preferably 45% by mass or less, and even more preferably 40% by mass or less, from the viewpoint of improving dispersion stability of the toner particles, thereby improving storage stability.

The content of the toner particles in the dispersion of toner particles subjected to wet-milling, based on 100 parts by mass of the insulating liquid, is preferably 10 parts by mass or more, more preferably 20 parts by mass or more, even more preferably 30 parts by mass or more, even more preferably 40 parts by mass or more, and even more preferably 50 parts by mass or more, from the viewpoint of high-speed printability, and the content is preferably 100 parts by mass or less, more preferably 80 parts by mass or less, even more preferably 70 parts by mass or less, and even more preferably 60 parts by mass or less, from the viewpoint of improving dispersion stability.

The wet-milling refers to a method of subjecting toner particles dispersed in an insulating liquid to a mechanical milling treatment in a dispersed state in the insulating liquid.

As the apparatus used, for example, generally used agitation mixers such as anchor blades can be used. Among the agitation mixers, the apparatuses include high-speed agitation mixers such as DESPA manufactured by ASADA IRON WORKS CO., LTD., and T.K. HOMOGENIZING MIXER manufactured by PRIMIX Corporation; pulverizers or kneaders, such as roller mills, beads-mills, kneaders, and extruders; and the like. These apparatuses can be used in a combination of plural apparatuses.

Among these apparatuses, use of beads-mill is preferred, from the viewpoint of making particle sizes of toner particles smaller, from the viewpoint of improving dispersion stability of the toner particles, thereby improving storage stability, and from the viewpoint of lowering the viscosity of a dispersion thereof

The solid content concentration of the liquid developer is preferably 10% by mass or more, more preferably 15% by mass or more, and even more preferably 20% by mass or more, from the viewpoint of improving optical density, and the solid content concentration is preferably 50% by mass or less, more preferably 45% by mass or less, and even more preferably 40% by mass or less, from the viewpoint of improving dispersion stability of the toner particles, thereby improving storage stability.

The content of the toner particles in the liquid developer is preferably 10% by mass or more, more preferably 15% by mass or more, and even more preferably 20% by mass or more, from the viewpoint of high-speed printing, and the content is preferably 50% by mass or less, more preferably 45% by mass or less, and even more preferably 40% by mass or less, from the viewpoint of dispersion stability of the toner particles.

The volume-median particle size D₅₀ of the toner particles in the liquid developer is preferably 0.5 μm or more, more preferably 1 μm or more, and even more preferably 1.5 μm or more, from the viewpoint of lowering the viscosity of the liquid developer, and the volume-median particle size is preferably 5 μm or less, more preferably 3 μm or less, and even more preferably 2.5 μm or less, from the viewpoint of improving image quality of the liquid developer.

The content of the insulating liquid in the liquid developer is preferably 50% by mass or more, more preferably 55% by mass or more, and even more preferably 60% by mass or more, from the viewpoint of dispersion stability of the toner particles, and the content is preferably 90% by mass or less, more preferably 85% by mass or less, even more preferably 80% by mass or less, and even more preferably 75% by mass or less, from the viewpoint of high-speed printing.

The viscosity at 25° C. of the liquid developer, a solid content concentration of which is 25% by mass is 50 mPa·s or less, preferably 45 mPa·s or less, more preferably 40 mPa·s or less, even more preferably 35 mPa·s or less, and even more preferably 25 mPa·s or less, from the viewpoint of improving fusing ability of the liquid developer, and the viscosity is preferably 3 mPa·s or more, more preferably 5 mPa·s or more, even more preferably 6 mPa·s or more, and even more preferably 7 mPa·s or more, from the viewpoint of improving dispersion stability of the toner particles, thereby improving storage stability.

The conductivity of the liquid developer of the embodiment A is 5.0×10⁻⁹ S/m or less, preferably 1.0×10⁻¹⁰ S/m or less, more preferably 7.0×10⁻¹¹ S/m or less, and more preferably 5.0×10⁻¹¹ S/m or less, and preferably 1.0×10⁻¹³ S/m or more, from the viewpoint of storage stability.

The present invention will be described hereinbelow more specifically by the Examples, without intending to limit the present invention to these Examples. The physical properties of the resins and the like were measured in accordance with the following methods.

[Softening Point of Resin]

Using a flow tester “CFT-500D,” manufactured by Shimadzu Corporation, a 1 g sample is extruded through a nozzle having a diameter of 1 mm and a length of 1 mm with applying a load of 1.96 MPa thereto with a plunger, while heating the sample at a heating rate of 6° C./min. The softening point refers to a temperature at which half of the sample flows out, when plotting a downward movement of the plunger of the flow tester against temperature.

[Glass Transition Temperature of Resin]

Using a differential scanning calorimeter “DSC210,” manufactured by Seiko Instruments Inc., a 0.01 to 0.02 g sample is weighed out in an aluminum pan, heated to 200° C., and cooled from that temperature to 0° C. at a cooling rate of 10° C./min. Next, the temperature of the sample is raised at a heating rate of 10° C./min to measure endothermic peaks. A temperature of an intersection of the extension of the baseline of equal to or lower than the highest temperature of endothermic peak and the tangential line showing the maximum inclination between the kick-off of the peak and the top of the peak is defined as a glass transition temperature.

[Acid Value of Resin]

The acid value is determined by a method according to JIS K0070:1992 except that only the determination solvent is changed from a mixed solvent of ethanol and ether as prescribed in JIS K0070 to a mixed solvent of acetone and toluene in a volume ratio of acetone:toluene=1:1.

[Volume-Median Particle Size of Toner Particles Before Mixing with Insulating Liquid]

Measuring Apparatus: Coulter Multisizer II, manufactured by Beckman Coulter, Inc.

### Aperture Diameter: 100 μm

Analyzing Software: Coulter Multisizer AccuComp Ver. 1.19, manufactured by Beckman Coulter, Inc.
Electrolytic Solution: Isotone II, manufactured by Beckman Coulter, Inc.
Dispersion: EMULGEN 109P, manufactured by Kao Corporation, polyoxyethylene lauryl ether, HLB (Griffin): 13.6, is dissolved in the above electrolytic solution to adjust to a concentration of 5% by mass to provide a dispersion.
Dispersion Conditions: Ten milligrams of a measurement sample is added to 5 mL of the above dispersion, and the mixture is dispersed for 1 minute with an ultrasonic disperser (name of machine: US-1, manufactured by SND Co., Ltd., output: 80 W). Thereafter, 25 mL of the above electrolytic solution is added to the dispersion, and further dispersed with the ultrasonic disperser for 1 minute, to prepare a sample dispersion.
Measurement Conditions: The above sample dispersion is added to 100 mL of the above electrolytic solution to adjust to a concentration at which particle sizes of 30,000 particles can be measured in 20 seconds, and the 30,000 particles are measured, and a volume-median particle size D₅₀ is obtained from the particle size distribution.

[Number-Average Molecular Weight (Mn) and Weight-Average Molecular Weight (Mw) of Amino Group-Containing Copolymer]

The molecular weight distribution is measured by gel permeation chromatography (GPC) method in accordance with the following method to obtain a number-average molecular weight (Mn) and a weight-average molecular weight (Mw).

### (1) Preparation of Sample Solution

A dispersant is dissolved in tetrahydrofuran so as to have a concentration of 0.5 g/100 mL. Next, this solution is filtered with a fluororesin filter “FP-200,” manufactured by Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, and stabilizing the column in a thermostat at 40° C., and loading 100 μL of a sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1.09×10⁶) as standard samples is used. The values within parentheses show molecular weights.

Measurement Apparatus: HLC-8220GPC, manufactured by Tosoh Corporation
Analyzing Column: TSKgel GMHXL+ TSKgel G3000HXL, manufactured by Tosoh Corporation.

[Weight-Average Molecular Weight (Mw) of Dispersant D of Example A Series]

The molecular weight distribution is measured by gel permeation chromatography (GPC) method to obtain a weight-average molecular weight.

### (1) Preparation of Sample Solution

A dispersant (one in which a dilution solvent is distilled off from the dispersant solution) is dissolved in chloroform so as to have a concentration of 0.2 g/100 mL. Next, this solution is filtered with a PTFE-type membrane filter “DISMIC-25JP,” manufactured by Toyo Roshi Kaisha, Ltd., having a pore size of 0.20 μm, to remove insoluble components, to provide a sample solution.

### (2) Molecular Weight Measurements

Using the following measurement apparatus and analyzing column, the measurement is taken by allowing a chloroform solution of 100 mmol/L FARMIN DM2098 manufactured by Kao Corporation to flow through a column as an eluent at a flow rate of 1 mL per minute, stabilizing the column in a thermostat at 40° C., and loading a 100 μl sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-5000 (5.97×10³), F-2 (1.81×10⁴), F-10 (9.64×10⁴), and F-40 (4.27×10⁵) as standard samples is used. The values within the parentheses show molecular weights.

Measurement Apparatus: HLC-8220GPC, manufactured by Tosoh Corporation
Analyzing Column: K-804L, manufactured by SHOWA DENKO CORPORATION

[Amine Values of Amino Group-Containing Copolymer, Dispersant D of Example A Series, and Acid Compound A of Example B Series]

The amine value is measured in accordance with ASTM D2074, except that chloroform is used for a solvent for dissolving a sample, and a 0.1 mol/L perchlorate acetate standard solution is used as a titration solution.

[Average Molecular Weight Mn of Acid Compound] (Example B Series)

### <Number-Average Molecular Weight (Mn) of PIBSA>

### (1) Preparation of Sample Solution

A sample is dissolved in tetrahydrofuran so as to have a concentration of 0.5 g/100 mL. Next, this solution is filtered with a fluororesin filter “FP-200,” manufactured by Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, and stabilizing the column in a thermostat at 40° C., and loading 100 μL of a sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1.09×10⁶) as standard samples is used. The values within parentheses show molecular weights.

Measurement Apparatus: HLC-8220GPC, manufactured by Tosoh Corporation
Analyzing Column: GMHXL+ G3000HXL, manufactured by Tosoh Corporation.

<Number-Average Molecular Weight (Mn) and Weight-Average Molecular Weight (Mw) of Acid Compounds A and B>(Example B Series)

The molecular weight distribution is measured by gel permeation chromatography (GPC) method as shown hereinbelow to obtain a number-average molecular weight (Mn) and a weight-average molecular weight (Mw).

### (1) Preparation of Sample Solution

A dispersant is dissolved in chloroform so as to have a concentration of 0.2 g/100 mL. Next, this solution is filtered with a fluororesin filter “FP-200,” manufactured by Sumitomo Electric Industries, Ltd., having a pore size of 0.2 μm, to remove insoluble components, to provide a sample solution.

### (2) Molecular Weight Measurements

Using the following measurement apparatus and analyzing column, the measurement is taken by allowing a chloroform solution of 1.00 mmol/L FARMIN DM2098 manufactured by Kao Corporation to flow through a column as an eluent at a flow rate of 1 mL per minute, stabilizing the column in a thermostat at 40° C., and loading a 100 μL it sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-5000 (5.97×10³), F-2 (1.81×10⁴), F-10 (9.64×10⁴), and F-40 (4.27×10⁵) as standard samples is used. The values within the parentheses show molecular weights.

Measurement Apparatus: HLC-8220GPC, manufactured by Tosoh Corporation
Analyzing Column: K-804L, manufactured by SHOWA DENKO CORPORATION

[Number-Average Molecular Weight (Mn) of Polymer Compound Having Basic Nitrogen-Containing Group] (Example B Series)

The molecular weight distribution is measured by gel permeation chromatography (GPC) method as shown hereinbelow to obtain a number-average molecular weight.

### (1) Preparation of Sample Solution

A sample is dissolved in a solution prepared by dissolving Na₂SO₄ in an aqueous 1% acetic acid solution at 0.15 mol/L so as to have a concentration of 0.2 g/100 mL. Next, this solution is filtered with a fluororesin filter “FP-200,” manufactured by Sumitomo Electric Industries, Ltd., having a pore size of 0.2 μm, to remove insoluble components, to provide a sample solution.

### (2) Molecular Weight Measurements

Using the following measurement apparatus and analyzing column, the measurement is taken by allowing a solution prepared by dissolving Na₂SO₄ in an aqueous 1% acetic acid solution at 0.15 mol/L to flow through a column as an eluent at a flow rate of 1 mL per minute, stabilizing the column in a thermostat at 40° C., and loading 100 μL of a sample solution thereto. The molecular weight of the sample is calculated based on the previously drawn calibration curve. At this time, a calibration curve which is drawn from several kinds of standard pullulans, manufactured by SHOWA DENKO CORPORATION, P-5 (5.9×10³), P-50 (4.73×10⁴), P-200 (2.12×10⁵), and P-800 (7.08×10⁵) as standard samples is used. The values within the parentheses show molecular weights.

Measurement Apparatus: HLC-8320GPC, manufactured by Tosoh Corporation
Analyzing Column: α+α-M+α-M, manufactured by Tosoh Corporation

[Conductivity of Insulating Liquid and Liquid Developer]

A 40-mL glass sample vial “Vial with screw cap, No. 7,” manufactured by Maruemu Corporation is charged with 25 g of a sample. The conductivity is determined by immersing an electrode in an insulating liquid, taking 20 measurements for conductivity at 25° C. with a non-aqueous conductivity meter “DT-700,” manufactured by Dispersion Technology, Inc., and calculating an average thereof. It is shown that the smaller the numerical figures, the higher the resistance.

[Boiling Point of Insulating Liquid]

Using a differential scanning calorimeter “DSC210,” manufactured by Seiko Instruments Inc., a 6.0 to 8.0 mg sample is weighed out in an aluminum pan, and the temperature of the sample is raised to 350° C. at a heating rate of 10° C./min to measure endothermic peaks. The highest temperature side of the endothermic peak is defined as a boiling point.

[Viscosities at 25° C. of Insulating Liquid and Liquid Developer]

A 10-mL sample vial with screw cap is charged with 6 to 7 mL of a measurement solution, and a viscosity at 25° C. is measured with a torsional oscillation type viscometer “VISCOMATE VM-10A-L,” manufactured by SEKONIC CORPORATION, having a detection terminal made of titanium, and a diameter of 8 mm by fixing the vial with a screw cap at a position that a liquid surface would be located 15 mm above a tip end of the detection terminal.

[Solid Content Concentrations of Dispersion of Toner Particles and Liquid Developer]

Ten parts by mass of a sample is diluted with 90 parts by mass of hexane, and the dilution is spun with a centrifuge “3-30KS,” manufactured by Sigma at a rotational speed of 25,000 r/min for 20 minutes. After allowing the mixture to stand, the supernatant is removed by decantation, the mixture is then diluted with 90 parts by mass of hexane, and the dilution is again centrifuged under the same conditions as above. The supernatant is removed by decantation, and a lower layer is then dried with a vacuum dryer at 0.5 kPa and 40° C. for 8 hours. The solid content concentration is calculated according to the following formula:

$$Solid Content Concentration , \% by Mass = \frac{Mass of Residues After Drying}{\begin{matrix}Mass of Sample , Corresponding to \\ 10 Parts by Mass Portion\end{matrix}} \times 100 \qquad [ Math Formula 1 ]$$

[Volume-Median Particle Size D₅₀ of Toner Particles in Liquid Developer]

A volume-median particle size D₅₀ is determined with a laser diffraction/scattering particle size measurement instrument “Mastersizer 2000,” manufactured by Malvern Instruments, Ltd., by charging a cell for measurement with Isopar L, manufactured by Exxon Mobile Corporation, isoparaffin, viscosity at 25° C. of 1 mPa·s, under conditions that a particle refractive index is 1.58, imaginary part being 0.1, and a dispersion medium refractive index is 1.42, at a concentration that gives a scattering intensity of from 5 to 15%.

Example A Series

Production Example 1 of Resin

A 10-L four-neck flask equipped with a nitrogen inlet tube, a dehydration tube, a stirrer, and a thermocouple was charged with raw material monomers for a polyester resin except for fumaric acid and trimellitic anhydride, an esterification catalyst and an esterification promoter as listed in Table A-1. The contents were heated with a mantle heater to 230° C., reacted at 230° C. for 8 hours, and further reacted under a reduced pressure of 8.3 kPa for 1 hour.

The temperature was lowered to 170° C., and raw material monomers for a styrenic resin, a dually reactive monomer and a polymerization initiator as listed in Table A-1 were added dropwise from a dropping funnel over 1 hour. The addition polymerization reaction was aged for 1 hour while keeping the temperature at 170° C., and the mixture was then heated to 210° C., to remove the raw material monomers for a styrenic resin at 8.3 kPa for 1 hour, and a reaction of the dually reactive monomer and the polyester moiety.

Further, trimellitic anhydride, fumaric acid, and 5 g of a polymerization inhibitor were added thereto at 210° C., and the mixture was reacted until a softening point reached as listed in Table A-1, to provide a composite resin (Resin A) having physical properties as shown in Table A-1.

Production Example 2 of Resin

A 10-L four-neck flask equipped with a nitrogen inlet tube, a dehydration tube, a stirrer, and a thermocouple was charged with raw material monomers for a polyester resin and an esterification catalyst as listed in Table A-1. The contents were heated with a mantle heater to 180° C. and then heated to 220° C. over 10 hours, and a mixture was reacted at 220° C. Further, the mixture was reacted at 8.3 kPa until a softening point reached as listed in Table A-1, to provide a polyester resin (Resin B) having physical properties as shown in Table A-1.

Production Example 3 of Resin

A 10-L four-neck flask equipped with a nitrogen inlet tube, a dehydration tube, a stirrer, and a thermocouple was charged with raw material monomers for a polyester resin other than trimellitic anhydride, an esterification catalyst, and a polymerization inhibitor as listed in Table A-1. The contents were heated with a mantle heater from 180° to 200° C. over 1 hour, and a mixture was reacted at 200° C. Thereafter, trimellitic anhydride was added thereto, and the mixture was reacted at 200° C. until a softening point reached as listed in Table A-1, to provide a polyester resin (Resin C) having physical properties as shown in Table A-1.

Production Example 4 of Resin

A 10-L four-neck flask equipped with a dehydration tube equipped with a nitrogen inlet tube, a stirrer, and a thermocouple was charged with alcohol components as listed in Table A-1, and the contents were heated to 100° C. Thereafter, terephthalic acid as listed in Table A-1 was added thereto, the mixture was heated to 160° C., an esterification catalyst and an esterification promoter were added thereto, and the mixture was reacted at 235° C. for 10 hours, and then reacted at 235° C. for 8.0 kPa for 1 hour. The reaction mixture was cooled to 160° C., polyisobutene succinic anhydride (manufactured by Dover, H1000, Mw: 1538) was added thereto, and the mixture was again subjected to a polycondensation reaction at 235° C. for 5 hours. Further, the mixture was reacted at 235° C. and 8.0 kPa until a softening point reached as listed in Table A-1, to provide a polyester resin (Resin D) having physical properties as shown in Table A-1.

TABLE A-1

| | | Resin A | Resin B | Resin C | Resin D |
|---|---|---|---|---|---|
| Raw Material | BPA-PO¹⁾ | 3,357 g | — | 3,747 g | 3,920 g |
| Monomers for | | (50) | | (50) | (80) |
| Polyester Resin | BPA-EO²⁾ | 3,117 g | — | 3,479 g | 910 g |
| | | (50) | | (50) | (20) |
| | 1,2-Propanediol | — | 3,528 g | — | — |
| | | | (100) | | |
| | Terephthalic acid | 2,101 g | 6,472 g | 2,346 g | 1,859 g |
| | | (66) | (84) | (66) | (80) |
| | Fumaric acid | 89 g | — | 99 g | — |
| | | (4) | | (4) | |
| | Trimellitic anhydride | 295 g | — | 329 g | — |
| | | (8) | | (8) | |
| | Polyisobutene succinic | — | — | — | 628 |
| | anhydride | | | | (9) |
| Dually Reactive | Acrylic acid | 41 g | — | — | — |
| Monomer | | (3) | | | |
| Raw Material | Styrene | 749 g | — | — | — |
| Monomers for | | (84) | | | |
| Styrenic Resin | 2-Ethylhexylacrylic acid | 143 g | — | — | — |
| | | (16) | | | |
| Polymerization | Dibutyl peroxide | 54 g | — | — | — |
| Initiator | | (6) | | | |
| Esterification | Tin(II) 2-ethylhexanoate | 45 g | 50 g | 45 g | 33 g |
| Catalyst | | | | | |
| Esterification | Gallic acid | 1 g | — | 1 g | 1 g |
| Promoter | | | | | |
| Polymerization | 4-t-Butyl catechol | 5 g | — | 5 g | — |
| Inhibitor | | | | | |
| Reaction water formed by polycondensation | | 549 g | 1,404 g | 612 g | 448 g |
| reaction (calculated value) | | | | | |
| Styrenic Resin/Polyester Resin (mass ratio) | | 10/90 | — | — | — |
| Physical | Softening Point, ° C. | 90 | 91 | 90 | 105 |
| Properties of | Glass Transition Temp., ° C. | 50 | 50 | 52 | 58 |
| Resin | Acid Value, mgKOH/g | 18 | 9 | 15 | 2 |

Note)
The numerical figures inside the parentheses in the raw material monomers for a polyester resin and the dually reactive monomer are expressed by a molar ratio when a total number of moles of the alcohol component is defined as 100, except that the polyisobutene succinic anhydride is expressed as a mass ratio based on 100 parts by mass of the raw material monomers of a polyester resin other than the polyisobutene succinic anhydride.
Also, the numerical figures inside the parentheses in the raw material monomers for a styrenic resin and a polymerization initiator are expressed by a mass ratio.
¹⁾BPA-PO: Polyoxypropylene(2.2)-2,2-bis(4-hydroxyphenyl)propane
²⁾BPA-EO: Polyoxyethylene(2.2)-2,2-bis(4-hydroxyphenyl)propane

Production Examples of Amino Group-Containing Copolymers

A 2-L four-neck flask equipped with a condenser, a nitrogen inlet tube, a stirrer, and a thermocouple was charged with 100 g of a solvent methyl ethyl ketone, and the internal of the reaction vessel was replaced with nitrogen gas. The internal of the reaction vessel was heated to 80° C., and a mixture of raw material monomers and a polymerization initiator as listed in Table A-2 was added dropwise over two hours to carry out a polymerization reaction. After the termination of the dropwise addition, the mixture was further reacted at 80° C. for 3 hours. The solvent was distilled off at 80° C., to provide amino group-containing copolymers (Dispersants A to C, E, and F) having physical properties as shown in Table A-2.

TABLE A-2

| | | Disper- | Disper- | Disper- | Disper- | Disper- |
|---|---|---|---|---|---|---|
| | | sant A | sant B | sant C | sant E | sant F |
| Raw | Dimethylaminoethyl | 50 g | 70 g | 30 g | — | 44 g |
| Material | methacrylate, | | | | | |
| Monomers | manufactured by | | | | | |
| | Wako Pure Chemical | | | | | |
| | Industries, Ltd. | | | | | |
| | Diethylaminoethyl | — | — | — | 55 g | — |
| | methacrylate, | | | | | |
| | manufactured by | | | | | |
| | Wako Pure Chemical | | | | | |
| | Industries, Ltd. | | | | | |
| | 1-Octadecyl | 50 g | 30 g | 70 g | 45 g | 56 g |
| | methacrylate (stearyl | | | | | |
| | methacrylate), | | | | | |
| | manufactured by | | | | | |
| | Wako Pure Chemical | | | | | |
| | Industries, Ltd. | | | | | |
| Polymerization | 2,2′-Azobis(2,4- | 3 g | 3 g | 3 g | 3 g | 3 g |
| Initiator | dimethylvaleronitrile), | | | | | |
| | manufactured by | | | | | |
| | Wako Pure Chemical | | | | | |
| | Industries, Ltd. | | | | | |
| Physical | Number-Average | 7,100 | 7,200 | 4,000 | 7,000 | 6,800 |
| Properties | Molecular Weight | | | | | |
| | Weight-Average | 12,600 | 12,700 | 18,000 | 12,400 | 12,500 |
| | Molecular Weight | | | | | |
| | Amine Value, | 171 | 249 | 92 | 176 | 151 |
| | mgKOH/g | | | | | |

### Examples 1 to 7 and Comparative Examples 1, 3 and 4

Eighty parts by mass of a resin binder as listed in Table A-4 and 20 parts by mass of a colorant “ECB-301” manufactured by DAINICHISEIKA COLOR & CHEMICALS MFG. CO., LTD., Phthalocyanine Blue 15:3, were previously mixed while stirring with a 20-L Henschel mixer for 3 minutes at a rotational speed of 1,500 r/min (peripheral speed 21.6 m/sec). Thereafter, the mixture was melt-kneaded under the conditions given below.

[Melt-Kneading Conditions]

A continuous twin open-roller type kneader “Kneadex,” manufactured by NIPPON COKE & ENGINEERING CO., LTD. having an outer diameter of roller of 14 cm and an effective length of roller of 55 cm was used. The operating conditions of the continuous twin open-roller type kneader were a rotational speed of a high-rotation side roller (front roller) of 75 r/min (peripheral speed of 32.4 m/min), a rotational speed of a low-rotation side roller (back roller) of 35 r/min (peripheral speed of 15.0 m/min), and a gap between the rollers at an end of the kneaded product charging side of 0.1 mm. The temperatures of the heating medium and the cooling medium inside the rollers were as follows. The high-rotation side roller had a temperature at the raw material charging side of 90° C., and a temperature at the kneaded product-discharging side of 85° C., and the low-rotation side roller had a temperature at the raw material charging side of 35° C., and a temperature at the kneaded product-discharging side of 35° C. In addition, the feeding rate of the raw material mixture to the kneader was 10 kg/h, and the average residence time in the kneader was about 3 minutes.

The kneaded product obtained above was roll-cooled with a cooling roller, and the cooled product was then roughly pulverized with a hammer-mill to a size of 1 mm or so. The roughly pulverized product obtained was finely pulverized and classified with an air jet type jet mill “IDS,” manufactured by Nippon Pneumatic Mfg. Co., Ltd., to provide toner particles having a volume-median particle size D₅₀ of 10 μm.

A 1-L polyethylene vessel was charged with 35 parts by mass of the toner particles obtained, 62.2 parts by mass of an insulating liquid as listed in Table A-4, and 2.1 parts by mass of a dispersant as listed in Table A-4 (6 parts by mass based on 100 parts by mass of the toner particles). The contents were stirred with “T.K. ROBOMIX,” manufactured by PRIMIX Corporation, under ice-cooling at a rotational speed of 7,000 r/min for 30 minutes, to provide a dispersion of toner particles, a solid content concentration of which was 36% by mass.

Next, the dispersion of toner particles obtained was subjected to wet-milling with 6 vessels-type sand mill “TSG-6,” manufactured by AIMEX CO., LTD., at a rotational speed of 1,300 r/min (peripheral speed 4.8 m/sec) using zirconia beads having a diameter of 0.8 mm at a volume filling ratio of 60% by volume to a volume-median particle size D₅₀ as listed in Table A-4. The beads were removed by filtration, and 44 parts by mass of the insulating liquid as listed in Table A-4 was added, based on 100 parts by mass of the filtrate, to dilute the filtrate, to provide a liquid developer having physical properties as shown in Table A-4, a solid content concentration of which was adjusted to 25% by mass.

### Comparative Example 2

The same procedures as in Example 1 were carried out except that the amount of the insulating liquid used was changed to 60.8 parts by mass, and that the amount of Dispersant D used was changed to 4.2 parts by mass (effective content of 6 parts by mass based on 100 parts by mass of the toner particles), respectively, to provide a liquid developer having physical properties as shown in Table A-4, a solid content concentration of which was adjusted to 25% by mass.

The details of the insulating liquids used in Examples and Comparative Examples are as follows.

TABLE A-3

| | | | | | Viscosity |
|---|---|---|---|---|---|
| Merchandize | Manufacturer | Chemical | Conductivity, | Boiling | at 25° C., |
| Name | and the like | Name | S/m | Point, ° C. | mPa · s |
| NAS-4 | NOF Corporation | Polyisobutene | 1.52 × 10⁻¹² | 247 | 2 |
| Isopar L | Exxon Mobile | Isoparaffin | 6.20 × 10⁻¹³ | 203 | 1 |
| | Corporation | | | | |
| Exxsol D110 | Exxon Mobile | Naphthenic | 1.69 × 10⁻¹² | 230 | 3 |
| | Corporation | hydrocarbon | | | |

Test Example 1—Storage Stability

A 10 mL-vial with screw cap was charged with 5 g of a liquid developer, and then stored in a thermostat held at 40° C. for 15 hours. The volume-median particle sizes D₅₀ of the toner particles before and after the storage were determined, and the storage stability was evaluated from a value (%) obtained by [D₅₀ After Storage]/[D₅₀ Before Storage]×100. The results are shown in Table A-4. It is shown that the more the numerical values approximates 100%, the more excellent the storage stability.

Test Example 2—Positive Chargeability

Two sheets of previously weighed electrodes (made of stainless steel, W 4 cm×D 0.5 cm×H 5 cm) were inserted into a Teflon(registered trademark) vessel (outer dimensions: W 6.3 cm×D 4 cm×H 6.3 cm, inner dimensions: W 5 cm×D 1.1 cm×H 5 cm) (distance between the electrodes: 0.1 cm). A liquid developer in an amount of 2.5 g was injected between two sheets of electrodes, and a direct current voltage of ±250 V was applied with a direct current power supply “TMK1.5-50” manufactured by TAKASAGO, LTD. for 60 seconds. Both the electrodes were taken out of the vessel, and the electrodes were dried with a vacuum dryer at 0.5 kPa and 100° C. for 15 minutes, to measure the mass of each of the electrodes after drying. At each of the negative electrode and positive electrode, a value calculated by (mass of the electrode after drying)−(mass of the electrode before applying voltage) was obtained, and defined as the mass of the toner particles adhered to each of the electrodes. The results are shown in Table A-4. It is shown that the larger the mass of the toner particles on the negative electrode and the smaller the mass of the toner particles on the positive electrode, the more excellent the positively chargeability.

TABLE A-4

| | | | | | Liquid Developer | | | | | | | |
|---|---|---|---|---|---|---|---|---|---|---|---|---|
| | | | | | | | | | | Positively Chargeability | | |
| | | | | | | | | | | Amount | Amount | |
| | | | Dispersant | | | | D₅₀ of | Storage Stability | | Adhered to | Adhered to | |
| | | | | Amine | | | Toner | D₅₀ After | | Negative | Positive | |
| | Resin | Insulating | | Value, | Viscosity, | Conductivity, | Particles | Storage | Y/X, | Electrode | Electrode | |
| | Binder | Liquid | Kinds | mgKOH/g | mPa · s | S/m | [X], μm | [Y], μm | % | [N], mg | [P], mg | N − P |
| Ex. 1 | Resin A | NAS-4 | Dispersant A | 171 | 21 | 3.23 × 10⁻¹¹ | 2.5 | 2.5 | 100 | 18 | 4 | 14 |
| Ex. 2 | Resin B | NAS-4 | Dispersant A | 171 | 18 | 4.86 × 10⁻¹¹ | 2.5 | 2.5 | 100 | 14 | 3 | 11 |
| Ex. 3 | Resin C | NAS-4 | Dispersant A | 171 | 24 | 3.56 × 10⁻¹¹ | 2.5 | 2.5 | 100 | 16 | 3 | 13 |
| Ex. 4 | Resin A | Isopar L | Dispersant A | 171 | 13 | 5.41 × 10⁻¹¹ | 2.5 | 2.5 | 100 | 14 | 2 | 12 |
| Ex. 5 | Resin A | NAS-4 | Dispersant B | 249 | 37 | 6.26 × 10⁻¹¹ | 3.0 | 3.2 | 107 | 20 | 4 | 16 |
| Ex. 6 | Resin D | NAS-4 | Dispersant A | 171 | 17 | 3.92 × 10⁻¹¹ | 2.5 | 2.5 | 100 | 14 | 2 | 12 |
| Ex. 7 | Resin A | NAS-4 | Dispersant E | 176 | 24 | 3.14 × 10⁻¹¹ | 2.5 | 2.5 | 100 | 19 | 3 | 16 |
| Comp. | Resin A | NAS-4 | Dispersant C | 92 | 15 | 2.11 × 10⁻¹¹ | 2.4 | 2.4 | 100 | 4 | 13 | −9 |
| Ex. 1 | | | | | | | | | | | | |
| Comp. | Resin A | NAS-4 | Dispersant D | 64 | 11 | 3.56 × 10⁻⁸ | 2.3 | 2.3 | 100 | 2 | 48 | −46 |
| Ex. 2 | | | | | | | | | | | | |
| Comp. | Resin A | Exxol | Dispersant A | 171 | 29 | 8.24 × 10⁻⁹ | 2.5 | 3.9 | 156 | 16 | 6 | 10 |
| Ex. 3 | | D110 | | | | | | | | | | |
| Comp. | Resin A | NAS-4 | Dispersant F | 151 | 19 | 2.95 × 10⁻¹¹ | 2.5 | 2.5 | 100 | 11 | 8 | 3 |
| Ex. 4 | | | | | | | | | | | | |

Dispersant D: “SOLSPARSE 11200,” manufactured by Lubrizol Corporation, a condensate of a polyethyleneimine and 12-hydroxystearic acid (average degree of polymerization: 7.0), Mw: 10,400, effective content: 50% by mass, amine value in terms of 100% effective content: 64 mgKOH/g

It can be seen from the above results that the liquid developers of Examples 1 to 7 have smaller particle sizes, lowered viscosity, and excellent storage stability and positive chargeability. On the other hand, in the liquid developer of Comparative Example 1 where a molar ratio of the monomer A in the amino group-containing copolymer is low and an amino value is low, the liquid developer shows negative chargeability, not positive chargeability, and the liquid developer of Comparative Example 4 also has insufficient positive chargeability. In addition, it can be seen that in the liquid developer of Comparative Example 2 containing a dispersant which has an amino group but does not have a given amino group-containing copolymer, the liquid developer shows an even stronger negative chargeability than Comparative Example 1. In the liquid developer of Comparative Example 3, the conductivity is high, and storage stability is deficient.

<Example B Series>

Production Example 1 of Resin

A 10-L four-neck flask equipped with a nitrogen inlet tube, a dehydration tube, a stirrer, and a thermocouple was charged with raw material monomers for a polyester resin except for fumaric acid and trimellitic anhydride, an esterification catalyst and an esterification promoter as listed in Table B-1. The contents were heated with a mantle heater to 230° C., reacted at 230° C. for 8 hours, and further reacted under a reduced pressure of 8.3 kPa for 1 hour.

The temperature was lowered to 170° C., and raw material monomers for a styrenic resin, a dually reactive monomer and a polymerization initiator as listed in Table B-1 were added dropwise from a dropping funnel over 1 hour. The addition polymerization reaction was aged for 1 hour while keeping the temperature at 170° C., and the mixture was then heated to 210° C., to carry out the removal of the raw material monomers for a styrenic resin at 8.3 kPa for 1 hour, and a reaction of the dually reactive monomer and the polyester moiety.

Further, trimellitic anhydride, fumaric acid, and 5 g of a polymerization inhibitor were added thereto at 210° C., and the mixture was reacted until a softening point reached as listed in Table B-1, to provide a composite resin (Resin A) having physical properties as shown in Table B-1.

Production Example 2 of Resin

A 10-L four-neck flask equipped with a nitrogen inlet tube, a dehydration tube, a stirrer, and a thermocouple was charged with raw material monomers for a polyester resin and an esterification catalyst as listed in Table B-1. The contents were heated with a mantle heater to 180° C. and then heated to 220° C. over 10 hours, and a mixture was reacted at 220° C. Further, the mixture was reacted at 8.3 kPa until a softening point reached as listed in Table B-1, to provide a polyester resin (Resin B) having physical properties as shown in Table B-1.

Production Example 3 of Resin

A 10-L four-neck flask equipped with a nitrogen inlet tube, a dehydration tube, a stirrer, and a thermocouple was charged with raw material monomers for a polyester resin other than trimellitic anhydride, an esterification catalyst, and a polymerization inhibitor as listed in Table B-1. The contents were heated with a mantle heater from 180° to 200° C. over 1 hour, and a mixture was reacted at 200° C. Thereafter, trimellitic anhydride was added thereto, and the mixture was reacted at 200° C. until a softening point reached as listed in Table B-1, to provide a polyester resin (Resin C) having physical properties as shown in Table B-1.

TABLE B-1

| | | Resin A | Resin B | Resin C |
|---|---|---|---|---|
| Raw Material | BPA-PO¹⁾ | 3,357 g | — | 3,747 g |
| Monomers for | | (50) | | (50) |
| Polyester Resin | BPA-EO²⁾ | 3,117 g | — | 3,479 g |
| | | (50) | | (50) |
| | 1,2-Propanediol | — | 3,528 g | — |
| | | | (100) | |
| | Terephthalic acid | 2,101 g | 6,472 g | 2,346 g |
| | | (66) | (84) | (66) |
| | Fumaric acid | 89 g | — | 99 g |
| | | (4) | | (4) |
| | Trimellitic anhydride | 295 g | — | 329 g |
| | | (8) | | (8) |
| Dually reactive | Acrylic acid | 41 g | — | — |
| monomer | | (3) | | |
| Raw Material | Styrene | 749 g | — | — |
| Monomers for | | (84) | | |
| Styrenic Resin | 2-Ethylhexylacrylic acid | 143 g | — | — |
| | | (16) | | |
| Polymerization | Dibutyl peroxide | 54 g | — | — |
| Initiator | | (6) | | |
| Esterification | Tin(II) 2-ethylhexanoate | 45 g | 50 g | 45 g |
| Catalyst | | | | |
| Esterification | Gallic acid | 1 g | — | 1 g |
| Promoter | | | | |
| Polymerization | 4-t-Butyl catechol | 5 g | — | 5 g |
| Inhibitor | | | | |
| Reaction water formed by polycondensation | | 549 g | 1,404 g | 612 g |
| reaction (calculated value) | | | | |
| Styrenic Resin/Polyester Resin (mass ratio) | | 10/90 | — | — |
| Physical | Softening Point, ° C. | 90 | 91 | 90 |
| Properties of | Glass Transition Temp., ° C. | 50 | 50 | 52 |
| Resin | Acid Value, mgKOH/g | 18 | 9 | 15 |

Note)
The numerical figures inside the parentheses in the raw material monomers for a polyester resin and the dually reactive monomer are expressed by a molar ratio when a total number of moles of the alcohol component is defined as 100.
Also, the numerical figures inside the parentheses in the raw material monomers for a styrenic resin and a polymerization initiator are expressed by a mass ratio.
¹⁾BPA-PO: Polyoxypropylene(2.2)-2,2-bis(4-hydroxyphenyl)propane
²⁾BPA-EO: Polyoxyethylene(2.2)-2,2-bis(4-hydroxyphenyl)propane

Production Examples of Amino Group-Containing Copolymers

A 2-L four-neck flask equipped with a condenser, a nitrogen inlet tube, a stirrer, and a thermocouple was charged with 100 g of a solvent methyl ethyl ketone, and the internal of the reaction vessel was replaced with nitrogen gas. The internal of the reaction vessel was heated to 80° C., and a mixture of raw material monomers and a polymerization initiator as listed in Table B-2 was added dropwise over two hours to carry out a polymerization reaction. After the termination of the dropwise addition, the mixture was further reacted at 80° C. for 3 hours. The solvent was distilled off at 80° C., to provide amino group-containing copolymers (Copolymers A to D) having physical properties as shown in Table B-2.

TABLE B-2

| | | Copolymer | Copolymer | Copolymer | Copolymer |
|---|---|---|---|---|---|
| | | A | B | C | D |
| Raw | Dimethylaminoethyl | 50 g | 30 g | 70 g | 50 g |
| Material | methacrylate, | | | | |
| Monomers | manufactured by Wako | | | | |
| | Pure Chemical | | | | |
| | Industries, Ltd. | | | | |
| | 1-Octadecyl | 50 g | 70 g | 30 g | — |
| | methacrylate (stearyl | | | | |
| | methacrylate), | | | | |
| | manufactured by | | | | |
| | Wako Pure Chemical | | | | |
| | Industries, Ltd. | | | | |
| | 1-Dodecyl methacrylate | — | — | — | 50 g |
| | (lauryl methacrylate), | | | | |
| | manufactured by | | | | |
| | Wako Pure Chemical | | | | |
| | Industries, Ltd. | | | | |
| Polymerization | 2,2′-Azobis(2,4- | 3 g | 3 g | 3 g | 3 g |
| Initiator | dimethylvaleronitrile), | | | | |
| | manufactured by Wako | | | | |
| | Pure Chemical | | | | |
| | Industries, Ltd. | | | | |
| Physical | Number-Average | 7,100 | 4,000 | 7,200 | 3,800 |
| Properties | Molecular Weight | | | | |
| | Weight-Average | 13,000 | 18,000 | 12,700 | 17,000 |
| | Molecular Weight | | | | |
| | Amine Value, | 171 | 92 | 249 | 171 |
| | mgKOH/g | | | | |

Production Example of Acid Compound

A 2-L four-neck flask equipped with a condenser, a nitrogen inlet tube, a stirrer, a dehydration tube, and a thermocouple was charged with a polyalkyleneimine as listed in Table B-3, and the internal of the reaction vessel was replaced with nitrogen gas. While stirring, a solution prepared by dissolving a polyisobutene succinic anhydride (PIBSA) as listed in Table B-3 in xylene was added dropwise thereto at 25° C. over one hour. After the termination of the dropwise addition, the mixture was held at 25° C. for 30 minutes. Thereafter, the internal of the reaction vessel was heated to 150° C. and held thereat for one hour, and then heated to 160° C. and held thereat for one hour. The pressure was reduced to 8.3 kPa at 160° C. to distill off the solvent. The time point at which a peak of acid anhydride ascribed to PIBSA (1,780 cm⁻¹) disappeared and a peak ascribed to imide bonding (1,700 cm⁻¹) was generated according to the IR analysis was defined as a reaction endpoint, to provide an acid compound (Acid Compound B) having physical properties as shown in Table B-3.

TABLE B-3

| | | Acid |
|---|---|---|
| | | Compound |
| | | B |
| Polyalkyleneimine | Polyethyleneimine 600, manufactured | 20 |
| | by JUNSEI CHEMICAL CO., LTD. | |
| | Structure | Branched |
| | Number-Average Molecular Weight | 1,500 |
| PIBSA | OLOA ® 15500, | 197 |
| | manufactured by Chevron Oronite, | |
| | effective content: 78% by mass | |
| | Number of Carbon Atoms of | 69 |
| | Polyolefin Unit | |
| | Number-Average Molecular Weight | 1,100 |
| Solvent | Xylene | 217 |
| Physical Properties | Number-Average Molecular Weight | 6,600 |
| | Weight-Average Molecular Weight | 76,700 |

### Examples 1, 3 to 5, and 10

Eighty parts by mass of a resin binder as listed in Table B-5 and 20 parts by mass of a colorant “ECB-301” manufactured by DAINICHISEIKA COLOR & CHEMICALS MFG. CO., LTD., Phthalocyanine Blue 15:3, were previously mixed while stirring with a 20-L Henschel mixer for 3 minutes at a rotational speed of 1,500 r/min (peripheral speed 21.6 m/sec). Thereafter, the mixture was melt-kneaded under the conditions given below.

[Melt-Kneading Conditions]

A continuous twin open-roller type kneader “Kneadex,” manufactured by NIPPON COKE & ENGINEERING CO., LTD. having an outer diameter of roller of 14 cm and an effective length of roller of 55 cm was used. The operating conditions of the continuous twin open-roller type kneader were a rotational speed of a high-rotation side roller (front roller) of 75 r/min (peripheral speed of 32.4 m/min), a rotational speed of a low-rotation side roller (back roller) of 35 r/min (peripheral speed of 15.0 m/min), and a gap between the rollers at an end of the kneaded product charging side of 0.1 mm. The temperatures of the heating medium and the cooling medium inside the rollers were as follows. The high-rotation side roller had a temperature at the raw material charging side of 90° C., and a temperature at the kneaded product-discharging side of 85° C., and the low-rotation side roller had a temperature at the raw material charging side of 35° C., and a temperature at the kneaded product-discharging side of 35° C. In addition, the feeding rate of the raw material mixture to the kneader was 10 kg/h, and the average residence time in the kneader was about 3 minutes.

The kneaded product obtained above was roll-cooled with a cooling roller, and the cooled product was then roughly pulverized with a hammer-mill to a size of 1 mm or so. The roughly pulverized product obtained was finely pulverized and classified with an air jet type jet mill “IDS,” manufactured by Nippon Pneumatic Mfg. Co., Ltd., to provide toner particles having a volume-median particle size D₅₀ of 10 μm.

A 1-L polyethylene vessel was charged with 35 parts by mass of the toner particles obtained, 62.2 parts by mass of an insulating liquid as listed in Table B-5, 1.4 parts by mass of an amino group-containing copolymer as listed in Table B-5 (4 parts by mass based on 100 parts by mass of the toner particles), and 1.4 parts by mass of an acid compound as listed in Table B-5 (4 parts by mass based on 100 parts by mass of the toner particles). The contents were stirred with “T.K. ROBOMIX,” manufactured by PRIMIX Corporation, under ice-cooling at a rotational speed of 7,000 r/min for 30 minutes, to provide a dispersion of toner particles, a solid content concentration of which was 36% by mass.

Next, the dispersion of toner particles obtained was subjected to wet-milling with 6 vessels-type sand mill “TSG-6,” manufactured by AIMEX CO., LTD., at a rotational speed of 1,300 r/min (peripheral speed 4.8 m/sec) using zirconia beads having a diameter of 0.8 mm at a volume filling ratio of 60% by volume to a volume-median particle size D₅₀ as listed in Table B-5. The beads were removed by filtration, and 44 parts by mass of the insulating liquid as listed in Table B-5 was then added, based on 100 parts by mass of the filtrate, to dilute the filtrate, to provide a liquid developer having physical properties as shown in Table B-5, a solid content concentration of which was adjusted to 25% by mass.

### Example 2

The same procedures as in Example 1 were carried out except that the amount of the insulating liquid used was changed to 62.9 parts by mass, and the amount of the amino group-containing copolymer used was changed to 0.7 parts by mass (2 parts by mass based on 100 parts by mass of the toner particles), respectively, to provide a liquid developer having physical properties as shown in Table B-5, a solid content concentration of which was adjusted to 25% by mass.

### Examples 6 and 7

The same procedures as in Example 1 were carried out except that the amount of the insulating liquid used was changed to 62.9 parts by mass, and the amount of the acid compound used was changed to 0.7 parts by mass (2 parts by mass based on 100 parts by mass of the toner particles), respectively, to provide a liquid developer having physical properties as shown in Table B-5, a solid content concentration of which was adjusted to 25% by mass.

### Example 8

The same procedures as in Example 1 were carried out except that the amount of the insulating liquid used was changed to 63.6 parts by mass, the amount of the amino group-containing copolymer used was changed to 1.05 parts by mass (3 parts by mass based on 100 parts by mass of the toner particles), and the amount of the acid compound used was changed to 0.35 parts by mass (1 part by mass based on 100 parts by mass of the toner particles), respectively, to provide a liquid developer having physical properties as shown in Table B-5, a solid content concentration of which was adjusted to 25% by mass.

### Example 9

The same procedures as in Example 1 were carried out except that the amount of the insulating liquid used was changed to 62.72 parts by mass, the amount of the amino group-containing copolymer used was changed to 1.75 parts by mass (5 parts by mass based on 100 parts by mass of the toner particles), and the amount of the acid compound used was changed to 0.53 parts by mass (1.5 parts by mass based on 100 parts by mass of the toner particles), respectively, to provide a liquid developer having physical properties as shown in Table B-5, a solid content concentration of which was adjusted to 25% by mass.

### Example 11

The same procedures as in Example 2 were carried out except that the timing of adding the acid compound was changed during the preparation of toner particles, to provide a liquid developer.

Specifically, toner particles were mixed with an insulating liquid and an amino group-containing copolymer, and the mixture was subjected to wet milling. Thereafter, a solid content concentration of the dispersion of toner particles was adjusted to 25% by mass. Thereafter, 1 part by mass of an acid compound was added to 100 parts by mass of the dispersion of toner particles (4 parts by mass based on 100 parts by mass of the toner particles), and the mixture was stirred with a ball-mill for 12 hours, to provide a liquid developer having physical properties as shown in Table B-5.

### Comparative Example 1

The same procedures as in Example 1 were carried out except that the amount of the insulating liquid used was changed to 62.9 parts by mass, the amount of the amino group-containing copolymer used was changed to 2.1 parts by mass (6 parts by mass based on 100 parts by mass of the toner particles), and the acid compound was not used, to provide a liquid developer having physical properties as shown in Table B-5, a solid content concentration of which was adjusted to 25% by mass.

### Comparative Example 2

The same procedures as in Example 1 were carried out except that the amount of the insulating liquid used was changed to 60.8 parts by mass, the amount of Acid Compound A used was changed to 4.2 parts by mass (6 parts by mass based on 100 parts by mass of the toner particles), and the amino group-containing copolymer was not used, to provide a liquid developer having physical properties as shown in Table B-5, a solid content concentration of which was adjusted to 25% by mass.

The details of the insulating liquids used in Examples and Comparative Examples are as follows.

TABLE B-4

| | | | | | Viscosity |
|---|---|---|---|---|---|
| Merchandize | Manufacturer | Chemical | Conductivity, | Boiling | at 25° C., |
| Name | and the like | Name | S/m | Point, ° C. | mPa · s |
| NAS-4 | NOF Corporation | Polyisobutene | 1.52 × 10⁻¹² | 247 | 2 |
| Isopar L | Exxon Mobile | Isoparaffin | 6.20 × 10⁻¹³ | 203 | 1 |
| | Corporation | | | | |

Test Example 1—Storage Stability

The storage stability was evaluated in accordance with the same method as in Test Example 1 of the Example A series. The results are shown in Table B-5.

Test Example 2—Positive Chargeability

The storage stability was evaluated in accordance with the same method as in Test Example 2 of the Example A series. The results are shown in Table B-5.

TABLE B-5

| | | | | | | | | Liquid Developer | | | | | | |
|---|---|---|---|---|---|---|---|---|---|---|---|---|---|---|
| | | | | | | | | | | | | Positive Chargeability | | |
| | | | Amino Group- | | | | | | | Storage | | Amount | Amount | |
| | | | Containing Copolymer | | | | | | | Stability | | Adhered | Adhered | |
| | | | | Amine | | Acid Compound | | | D₅₀ of | D₅₀ [Y] | | to | to | |
| | | | | Value, | | Acid | | | Toner | After | | Negative | Positive | |
| | Resin | Insulating | Copol- | mgKOH/ | Amount | Com- | Amount | Viscosity, | Particles | Storage, | Y/X, | Electrode | Electrode | |
| | Binder | Liquid | ymer | g | Used | pound | Used | mPa · s | [X], μm | μm | % | [N], % | [P], % | N − P |
| Ex. 1 | Resin A | NAS-4 | Copol- | 171 | 4 | Oleic | 4 | 15 | 2.3 | 2.3 | 100 | 40 | 1 | 39 |
| | | | ymer A | | | acid | | | | | | | | |
| Ex. 2 | Resin A | NAS-4 | Copol- | 171 | 2 | PIBSA | 4 | 13 | 2.3 | 2.3 | 100 | 24 | 2 | 22 |
| | | | ymer A | | | | | | | | | | | |
| Ex. 3 | Resin B | NAS-4 | Copol- | 171 | 4 | Oleic | 4 | 13 | 2.3 | 2.3 | 100 | 37 | 2 | 35 |
| | | | ymer A | | | acid | | | | | | | | |
| Ex. 4 | Resin C | NAS-4 | Copol- | 171 | 4 | Oleic | 4 | 18 | 2.3 | 2.3 | 100 | 38 | 1 | 37 |
| | | | ymer A | | | acid | | | | | | | | |
| Ex. 5 | Resin A | Isopar L | Copol- | 171 | 4 | Oleic | 4 | 10 | 2.2 | 2.3 | 105 | 43 | 1 | 42 |
| | | | ymer A | | | acid | | | | | | | | |
| Ex. 6 | Resin A | NAS-4 | Copol- | 171 | 4 | Acid | 2 | 10 | 2.3 | 2.3 | 100 | 29 | 4 | 25 |
| | | | ymer A | | | Com- | | | | | | | | |
| | | | | | | pound A | | | | | | | | |
| Ex. 7 | Resin A | NAS-4 | Copol- | 171 | 4 | Acid | 2 | 12 | 2.3 | 2.3 | 100 | 38 | 3 | 35 |
| | | | ymer A | | | Com- | | | | | | | | |
| | | | | | | pound B | | | | | | | | |
| Ex. 8 | Resin A | NAS-4 | Copol- | 92 | 3 | Acid | 1 | 11 | 2.3 | 2.3 | 100 | 23 | 3 | 20 |
| | | | ymer B | | | Com- | | | | | | | | |
| | | | | | | pound B | | | | | | | | |
| Ex. 9 | Resin A | NAS-4 | Copol- | 249 | 5 | Acid | 1.5 | 23 | 2.5 | 2.6 | 104 | 31 | 2 | 29 |
| | | | ymer C | | | Com- | | | | | | | | |
| | | | | | | pound B | | | | | | | | |
| Ex. 10 | Resin A | NAS-4 | Copol- | 171 | 4 | Oleic | 4 | 20 | 2.4 | 2.5 | 104 | 35 | 3 | 32 |
| | | | ymer D | | | acid | | | | | | | | |
| Ex. 11 | Resin A | NAS-4 | Copol- | 171 | 2 | PIBSA | 4 | 12 | 2.4 | 2.4 | 100 | 89 | 0 | 89 |
| | | | ymer A | | | | | | | | | | | |
| Comp. | Resin A | NAS-4 | Copol- | 92 | 6 | — | — | 15 | 2.4 | 2.4 | 100 | 4 | 13 | −9 |
| Ex. 1 | | | ymer B | | | | | | | | | | | |
| Comp. | Resin A | NAS-4 | — | — | — | Acid | 6 | 11 | 2.3 | 2.3 | 100 | 2 | 48 | −46 |
| Ex. 2 | | | | | | Com- | | | | | | | | |
| | | | | | | pound A | | | | | | | | |

Note 1)
The amounts of the amino group-containing copolymer and the acid compound used are amounts used based on 100 parts by mass of the toner particles.
Note 2)
Acid Compound A: SOLSPARSE 11200, manufactured by Lubrizol Corporation
Condensate of polyethyleneimine and 12-hydroxystearic acid (average degree of polymerization: 7.0), Mw 10,400, effective content: 50% by mass, amine value in terms of 100% effective content: 64 mgKOH/g

It can be seen from the above results that the liquid developers of Examples 1 to 11 have smaller particle sizes, lowered viscosity, and excellent storage stability and positive chargeability. On the other hand, the liquid developer of Comparative Example 1 without containing an acid compound shows negative chargeability, not positive chargeability. In addition, it can be seen that the liquid developer of Comparative Example 2 containing an acid compound which has an amino group but not containing a given amino group-containing copolymer shows an even stronger negative chargeability than Comparative Example 1.

The liquid developer of the present invention is suitably used in development or the like of latent images formed in, for example, electrophotography, electrostatic recording method, electrostatic printing method or the like.

1: A liquid developer, comprising:
toner particles comprising a resin binder and a colorant;
an amino group-containing copolymer; and
an insulating liquid,
wherein the resin binder comprises a polyester-based resin,
the amino group-containing copolymer is a polymerized product of a monomer A having an amino group and a monomer B represented by the formula (I): 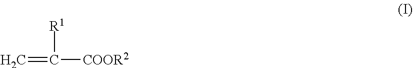
wherein R¹ is a hydrogen atom or a hydrocarbon group having 1 or more carbon atoms and 5 or less carbon atoms; and R² is a hydrocarbon group having 1 or more carbon atoms and 22 or less carbon atoms, which may have a substituent, and
the liquid developer satisfies (1) or (2):
(1): an amine value of the amino group-containing copolymer is 165 mgKOH/g or more and 300 mgKOH/g or less, and a conductivity of the liquid developer is 5.0×10⁻⁹ S/m or less; or
(2): the liquid developer further comprises an acid compound, which is an aliphatic acid, an aliphatic dicarboxylic acid or an anhydride thereof, or a polymer compound having a carboxy group or an anhydride thereof.

2: The liquid developer according to claim 1, wherein the monomer A is
a monomer having an amino group represented by the formula (III):
CH₂═C(R⁵)COYR⁶NR³R⁴ (III)
wherein each of R³ and R⁴ is independently a hydrogen atom or a linear or branched alkyl group having 1 or more carbon atoms and 4 or less carbon atoms, which may be bonded to each other to form a ring structure; R⁵ is a hydrogen atom or an alkyl having 1 or more carbon atoms and 5 or less carbon atoms; R⁶ is a linear or branched alkylene group having 2 or more carbon atoms and 4 or less carbon atoms; and Y is —O— or —NH—, or
an acid neutralized product or a quaternary ammonium salt of the monomer.

3: The liquid developer according to claim 1, further comprising:
a dispersant,
wherein the dispersant comprises an amino group-containing copolymer in an amount of 25% by mass or more.

4: The liquid developer according to claim 1, wherein the polyester-based resin is a polyester resin, or a composite resin comprising a polyester resin and a styrenic resin.

5: The liquid developer according to claim 1, wherein an acid value of the polyester-based resin is 5 mgKOH/g or more and 70 mgKOH/g or less.

6: The liquid developer according to claim 1, wherein the insulating liquid comprises a hydrocarbon-based insulating liquid.

7: The liquid developer according to claim 1, wherein the insulating liquid comprises an acyclic hydrocarbon-based insulating liquid in an amount of 50% by mass or more.

8: The liquid developer according to claim 1, wherein when the liquid developer satisfies (2), a mass ratio of the monomer A to the monomer B (monomer A/monomer B) is 20/80 or more and 80/20 or less.

9. (canceled)

10: The liquid developer according to claim 1, wherein when the liquid developer satisfies (2), a mass ratio of the amino group-containing copolymer to the acid compound (amino group-containing copolymer/acid compound) is 30/70 or more and less than 90/10.

11. (canceled)

12: The liquid developer according to claim 1, wherein when the liquid developer satisfies (2), an amine value of the amino group-containing copolymer is 80 mgKOH/g or more.

13: The liquid developer according to 1, wherein when the liquid developer satisfies (2), an amine value of the amino group-containing copolymer is 150 mgKOH/g or more and 300 mgKOH/g or less.

14: The liquid developer according to claim 1, wherein a weight-average molecular weight of the amino group-containing copolymer is 5,000 or more and 100,000 or less.

15: The liquid developer according to claim 1, wherein a conductivity of the liquid developer is 1.0×10⁻¹⁰ S/m or less and 1.0×10⁻¹³ S/m or more.

16: A method, comprising:
developing a latent image with a composition comprising toner particles comprising a resin binder and a colorant, an amino group-containing copolymer, and an insulating liquid,
wherein the resin binder comprises a polyester-based resin,
the amino group-containing copolymer is a polymerized product of a monomer A having an amino group and a monomer B represented by the formula (I): 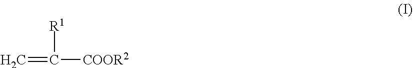
wherein R¹ is a hydrogen atom or a hydrocarbon group having 1 or more carbon atoms and 5 or less carbon atoms; and R² is a hydrocarbon group having 1 or more carbon atoms and 22 or less carbon atoms, which may have a substituent, and
the composition satisfies (1) or (2):
(1): an amine value of the amino group-containing copolymer is 165 mgKOH/g or more and 300 mgKOH/g or less, and a conductivity of the liquid developer is 5.0×10⁻⁹ S/m or less; or
(2): the composition further comprises an acid compound, which is an aliphatic acid, an aliphatic dicarboxylic acid or an anhydride thereof, or a polymer compound having a carboxy group or an anhydride thereof.
